(19) United States
(12) Patent Application Publication
(10) Pub. No.: US 2018/0038642 A1
(43) Pub. Date: Feb. 8, 2018

(54) PROCESS INTEGRATION OF A GAS PROCESSING UNIT WITH LIQUEFACTION UNIT

(71) Applicant: L'Air Liquide, Societe Anonyme pour l'Etude et l'Exploitation des Procedes Georges Claude, Paris (FR)

(72) Inventors: Alexander ROESCH, Katy, TX (US); Alain GUILLARD, Houston, TX (US); Michael A. TURNEY, Houston, TX (US)

(73) Assignee: L'Air Liquide, Societe Anonyme pour l'Etude et l'Exploitation des Procedes Georges Claude, Paris (FR)

(21) Appl. No.: 15/414,170

(22) Filed: Jan. 24, 2017

Related U.S. Application Data
(60) Provisional application No. 62/371,497, filed on Aug. 5, 2016.

(51) Int. Cl. F25J 1/02; B01D 53/047; C01B 3/56; B01D 53/48; F25J 1/00; C01B 3/34

(52) U.S. Cl. CPC F25J 1/023; F25J 1/0022; F25J 1/0228; F25J 1/0229; F25J 1/0072; F25J 1/0082; F25J 1/0234; F25J 1/005; F25J 1/001; C01B 3/34; C01B 3/56; B01D 53/48; B01D 53/047; F25J 2230/42; F25J 2230/22; F25J 2230/60; F25J 2290/60; F25J 2270/14; F25J 2200/06; F25J 2210/60; F25J 2215/04; F25J 2240/70; F25J 2240/12; F25J 2240/04; F25J 2270/04; F25J 2210/06; F25J 2230/04; C01B 2203/0216; C01B 2203/042; C01B 2203/1241; C01B 2203/1258; C01B 2203/061; B01D 2259/40086; B01D 2257/30; B01D 2256/24; B01D 2256/16

(57) ABSTRACT

It is proposed to integrate a gas processing unit with a liquefaction unit. The industrial gas stream may be but is not limited to air gases of oxygen, nitrogen argon, hydrocarbon, LNG, syngas or its components, CO₂, or any other molecule or combination of molecules. It is proposed to integrate the underutilized process inefficiencies of a gas processing unit into the liquefaction unit to produce a liquid at a reduced operating cost. The gas processing unit may be any system or apparatus which alters the composition of a feed gas. Examples could be, but are not limited to, a methanol plant, steam methane reformer, cogeneration plant, and partial oxidation unit.

### RELATED APPLICATIONS

This application is a non-provisional application of U.S. Provisional Applicant No. 62/371,497, filed Aug. 5, 2016, which is herein incorporated by reference in its entirety.

### TECHNICAL FIELD OF THE INVENTION

The present invention generally relates to a method for efficiently producing liquefied natural gas (LNG). More particularly, the present invention relates to a method for integrating LNG production with a syngas production facility, wherein pressurized steam from the syngas production facility is used to power a steam turbine, which in turn provides power for a recycle compressor of a refrigeration cycle used to liquefy the natural gas.

### BACKGROUND OF THE INVENTION

Many locations utilize a high pressure (transmission) network and a lower pressure (distribution) network to supply natural gas through a local area. The transmission network typically acts as a freeway to economically send the gas over long distances to the general area, while the distribution network acts as the roads to send the gas to the individual users within a local area. Pressures of these networks vary by location, but typical values are between 30-80 bara for transmission and 3-20 bara for distribution. Some applications (e.g., cogeneration, boilers, etc . . . ) have high flowrates of natural gas and other utilities such as nitrogen, which are letdown to the consumer or to the lower pressure network at relatively constant flow, pressure and temperature conditions. This pressure letdown energy is often not utilized.

Traditionally, natural gas is compressed and sent through pipelines under high pressure to transport the gas to customers. High pressures are used in order to reduce the volumetric flow of the gas thereby reducing pipe diameters (capex) and/or compression energy related to pressure losses (opex). Pipeline operators also utilize the high pressure as a buffer to accommodate transient demands. When the gas has arrived at its use point, the pressure of the natural gas is reduced in one or more control valves to its final pressure for consumption. The available energy from the reduction in pressure of the natural gas is wasted in the control valves as well as any chilling effect (also known as the Joule Thomson effect) caused by the flow of natural gas through these devices. Additionally, such systems often require heaters and condensate systems due to the colder conditions of the downstream gas.

In the past, advantage has been taken of this wasted energy by facilities utilizing the energy and refrigeration effect of expanding the natural gas. One such facility employed a natural gas pressure reduction station (“Letdown Station”) to make liquefied natural gas (“LNG”) or liquid nitrogen (“LIN”). A majority of the natural gas entering the plant under high pressure from the transportation pipeline was cooled and sent to an expansion turbine where energy and refrigeration were generated. The remainder of the stream was subsequently cooled with the refrigeration and a portion liquefied. The liquefied portion was then passed to a storage tank as LNG product. The natural gas that was not liquefied was warmed, collected and sent to the low pressure header at a lower pressure than the high-pressure header.

U.S. Pat. No. 6,196,021 describes a system that uses natural gas expansion to provide refrigeration to liquefy a natural gas stream, which is then vaporized by heat exchange with a nitrogen stream to cool the nitrogen stream. This refrigeration supplements refrigeration provided by nitrogen pressure letdown and a nitrogen cycle to provide liquid nitrogen.

Similarly, U.S. Pat. No. 6,131,407 describes a system that produces LIN to be sent directly to an air separation unit (“ASU”) to assist refrigeration of the ASU. U.S. Patent Application Publication No. 2014/0352353 describes a similar system to the system of disclosed by U.S. Pat. No. 6,131,407, but adds that the LIN produced can be sent to a tank instead of being used to liquid assist the ASU. In each of these systems, the produced LNG is revaporized in order to provide cooling for the production of liquid nitrogen.

U.S. Pat. No. 6,694,774 describes a system that uses natural gas letdown to provide refrigeration to produce a liquefied natural gas stream, where the refrigeration is supplemented by a closed loop mixed refrigerant cycle. Expansion of the pressurized natural gas provides the “high temperature” cooling and the mixed gas refrigerant cycle provides the low temperature cooling for liquefaction of a second portion of the natural gas. The primary point of emphasis in '774 was to power the compressor of the refrigeration cycle using work generated by the expansion of the pressurized natural gas stream. However, in embodiments in which the gas to be liquefied must be compressed prior to liquefaction, the power used to run the compressor is provided by an electric motor.

Therefore, it would be advantageous to provide a method and apparatus that operated in a more efficient manner yielding a lower cost of LNG.

### SUMMARY OF THE INVENTION

The present invention is directed to a method and apparatus that satisfies at least one of these needs. In certain embodiments, the invention can provide a lower cost, more efficient and flexible method to produce LNG.

There is a demand to reduce the cost of liquefying a natural gas stream. In one embodiment of the present invention, a method for producing lower cost liquid natural gas is provided by integrating a syngas production facility, which can include a steam methane reformer (SMR), an autothermal reactor (ATR), or an ATR in combination with the SMR, with the LNG liquefaction unit.

In a typical syngas production facility, excess heat is produced, which is usually converted to high pressure steam. This high pressure steam is letdown in a steam turbine, which drives an electric generator, with the resulting produced electricity being sold back to the grid. Additionally, these syngas production facilities require low pressure natural gas as fuel and high pressure natural gas as process feed, and are typically located near high pressure natural gas pipelines.

Embodiments of the present invention provide for a lower cost LNG by integrating the syngas production facility with a natural gas liquefaction unit. Additionally, in certain embodiments of the invention, the natural gas liquefaction unit utilizes the letdown energy available from the high pressure natural gas in order to provide a portion of the cooling (e.g., warm temperature cooling), while a second portion of the cooling (e.g., cold temperature cooling) is provided by a refrigeration cycle (for example, a nitrogen refrigeration cycle). In certain embodiments, the refrigeration cycle can include a recycle compressor that is directly driven by the steam turbine of the syngas production facility.

A method for the production of liquefied natural gas (“LNG”) is provided. In one embodiment, the method can include the steps of: a) operating a syngas production facility that is configured to convert a first natural gas stream into a syngas stream using an endothermic reaction, wherein the endothermic reaction is assisted by burning a second natural gas stream as fuel to provide heat for the endothermic reaction thereby producing a hot flue gas, wherein the hot flue gas is cooled against a pressurized water stream thereby producing pressurized steam, wherein the pressurized steam is fed to a steam turbine; b) cooling and liquefying a third natural gas stream using refrigeration provided by at least two different sources to produce an LNG product stream; c) providing a first source for the refrigeration used in step b) by expanding the second natural gas stream in a natural gas expander and then warming the second natural gas stream, prior to being burned as fuel in step a), against the third natural gas stream; and d) providing a second source for the refrigeration used in step b) using a nitrogen refrigeration cycle, wherein the nitrogen refrigeration cycle comprises a nitrogen recycle compressor and at least one turbine, and at least one booster, wherein the at least one turbine is configured to power the at least one booster, wherein the nitrogen recycle compressor is at least partially driven by the steam turbine of the syngas production facility.

In optional embodiments of the method for the production of LNG:

the first natural gas stream, the second natural gas stream, and the third natural gas stream all originate from a common source, wherein the common source is a pressurized natural gas pipeline;

the nitrogen refrigeration cycle comprises the steps of compressing nitrogen refrigerant in the nitrogen recycle compressor, further compressing the nitrogen refrigerant in the at least one booster, cooling the nitrogen refrigerant in the heat exchanger, withdrawing the nitrogen refrigerant from an intermediate portion of the heat exchanger and then expanding the nitrogen refrigerant in the at least one turbine to produce a cold nitrogen refrigerant; and warming the cold nitrogen refrigerant against the third natural gas stream;

the second natural gas stream is warmed against the third natural gas stream in a first heat exchanger and the nitrogen refrigerant is warmed against the third natural gas stream in a second heat exchanger;

the first heat exchanger and the second heat exchanger are disposed within one heat exchanger unit;

the outlet temperature of the natural gas turbine is warmer than the temperature at the outlet of the cold nitrogen turbine;

the first source for the refrigeration is provided in step c) at a first temperature, wherein the second source for the refrigeration is provided in step d) at a second temperature, wherein the second temperature is colder than the first temperature;

the first source for the refrigeration provided in step c) and the second source for the refrigeration provided in step d) are provided without using externally provided electricity;

the refrigeration used to liquefy the third natural gas stream during step b) is produced without the use of externally provided electricity;

the refrigeration used to liquefy the third natural gas stream during step b) is produced with reduced amounts of externally provided electricity;

the second natural gas stream and the third natural gas stream are boosted in a natural gas booster prior to steps b) and c);

the natural gas expander comprises a natural gas expansion turbine; and/or

the natural gas turbine powers the natural gas booster.

In another embodiment, the method for the production LNG can include the steps of: utilizing letdown energy of a high pressure natural gas stream that is withdrawn from a natural gas pipeline to provide a warm temperature cooling; utilizing a refrigeration cycle to provide a cold temperature cooling, wherein the refrigeration cycle comprises a refrigerant recycle compressor that is powered utilizing a steam turbine, wherein the steam turbine is powered by high pressure steam, wherein the high pressure steam is produced from a syngas production facility; and cooling a second high pressure natural gas stream using the warm temperature cooling and the cold temperature cooling to produce an LNG product stream, wherein the second high pressure natural gas stream is withdrawn from the natural gas pipeline.

In optional embodiments of the method for the production of LNG:

the natural gas pipeline is operated at a pressure between 15 and 100 bara; and/or

the refrigeration cycle is selected from the group consisting of a nitrogen refrigeration cycle and a mixed refrigerant refrigeration cycle.

As noted earlier, the typical methanol process described above includes at least two streams: high pressure natural gas letdown to fuel and hydrogen rich purge as letdown as fuel, which do not utilize the high pressure energy available.

In certain embodiments, the potential high pressure energy of these two streams may be utilized by expansion of the two streams in conjunction with expansion of a third pressurized gas stream originating from an ASU for refrigeration purposes.

In one embodiment, at least a portion of the natural gas and the hydrogen rich purge streams are diverted to an exchanger where they are cooled down, then expanded in turbines to extract energy and produce colder process streams which are then re-warmed in the exchanger to cool the turbine inlet streams as well as the fluid to be liquefied (e.g. natural gas, ethane, methane, nitrogen, hydrogen, ethylene, etc . . . ).

The third source of refrigeration can be provided by expansion of a pressurized gas stream originating from an ASU such as air from the discharge of the booster air compressor (BAC), pressurized nitrogen from a pipeline or a nitrogen compressor, and combinations thereof. For purposes herein, nitrogen sourced from a pipeline is considered to be a pressurized gas stream originating from an ASU.

In normal operation of an ASU, it is typical for the BAC to not be operating at its maximum design condition. This is because the maximum design conditions are often based on worst case conditions (e.g., maximum liquid products, maximum high pressure gaseous oxygen, summer conditions, etc . . . ), which may be occasionally required but are rarely an actual operating point. Additionally, the design capacities of the major equipment such as MAC and BAC can be maximized to the limit of a step change in capital cost, for example based on the limit of a compressor frame size. Therefore, in a typical air separation unit, there is often excess capacity available from the BAC, the MAC and pretreatment such that high pressure air can be withdrawn from the ASU at approximately 15-100 bara with some operating cost but with little or zero additional capital cost.

Therefore, certain embodiments of the invention provide for an improved process for liquefaction of an industrial gaseous stream, for example natural gas, that incorporates the available wasted energy of these two processes in an efficient manner.

In one embodiment, a method for the liquefaction of an industrial gas selected from the group consisting of natural gas, nitrogen, hydrogen, and combinations thereof, is provided. In one embodiment, the method can include the steps of: a) withdrawing a pressurized natural gas stream from a natural gas pipeline; b) removing carbon dioxide and water from the pressurized natural gas stream; c) expanding the pressurized natural gas stream to form an expanded natural gas stream and warming the expanded natural gas stream in a first portion of a heat exchanger against the industrial gas to form a warmed natural gas stream; d) sending the warmed natural gas stream to a methanol production facility under conditions effective for producing a methanol stream, a purified hydrogen stream, and a purge gas rich in hydrogen; e) expanding the purge gas rich in hydrogen to form an expanded purge gas and warming the expanded purge gas in a second portion of the heat exchanger against the industrial gas to form a warmed purge gas stream; f) sending the warmed purge gas stream to the methanol production facility for use as fuel; and g) expanding a pressurized air gas stream from or derived from an air separation unit (ASU) to form an expanded air gas stream and warming the expanded air gas stream in a third portion of the heat exchanger against the industrial gas to form a warmed air gas stream, wherein the industrial gas is liquefied during step g).

In optional embodiments of the method for the liquefaction of the industrial gas:

the air gas from or derived from an ASU is a gas stream selected from the group consisting of compressed and purified air from a booster air compressor, a nitrogen stream from a nitrogen pipeline, and combinations thereof; and/or

the industrial gas further comprises trace components having a freezing point temperature warmer than that of methane, wherein the first portion of the heat exchanger and the second portion of the heat exchanger are kept at temperatures warmer than the freezing point temperature of the trace components, and wherein the trace components are removed from the industrial gas prior to the industrial gas being cooled in the third portion of the heat exchanger.

In another embodiment, the method for the liquefaction of the industrial gas can include the steps of: (a) providing a pressurized natural gas stream, a pressurized purge gas stream originating from a methanol plant, and a pressurized air gas stream comprising an air gas originating from an air separation unit (ASU), wherein the pressurized purge gas stream is comprised predominately of hydrogen, wherein the pressurized air gas stream has an oxygen concentration at or below that of atmospheric air; (b) expanding three different pressurized gases to produce three cooled streams, wherein the three different pressurized gases consist of the pressurized natural gas stream, the pressurized purge gas stream, and the pressurized air gas stream; and (c) liquefying the industrial gas in a liquefaction unit against the three cooled streams to produce a liquefied industrial gas stream, wherein the industrial gas to be liquefied is selected from the group consisting of a first portion of the pressurized natural gas stream, a nitrogen gas stream from a nitrogen pipeline, and combinations thereof.

In optional embodiments of the method for the liquefaction of the industrial gas:

the air gas originating from an ASU is a gas stream selected from the group consisting of compressed and purified air from a booster air compressor, a nitrogen stream from a nitrogen pipeline, and combinations thereof, wherein the air gas from the ASU is at a pressure between 15 to 100 bara;

the pressurized natural gas stream comprises methane and trace components, wherein the trace components have freezing point temperatures that are warmer than that of methane;

the trace components have freezing point temperatures warmer than about 140° C.;

in steps (b) and (c): the pressurized natural gas stream provides a first portion of cooling to the industrial gas, the pressurized purge gas stream provides a second portion of cooling to the industrial gas, and the pressurized air gas stream provides a third portion of cooling to the industrial gas, wherein the third portion of the cooling is at a temperature that is colder than the first portion of cooling and the second portion of cooling;

the second portion of cooling is provided to the industrial gas in a first heat exchanger, wherein the third portion of cooling is provided to the industrial gas in a second heat exchanger;

the pressurized air gas stream has an oxygen content above the combustibility limit of oxygen in hydrogen;

the pressurized air gas stream has an oxygen content at or below the combustibility limit of oxygen in hydrogen;

the pressurized air gas stream further comprises nitrogen gas from a nitrogen pipeline;

at least a portion of the air gas of the pressurized air gas stream is withdrawn from an outlet of a booster air compressor (BAC) of the ASU;

the flow of air gas withdrawn from the outlet of the BAC and provided in step (a) accounts for less than about 20% of the total volumetric flow of air coming from the outlet of the BAC;

the flow of air gas withdrawn from the outlet of the BAC and provided in step (a) accounts for less than about 5% of the total volumetric flow of air coming from the outlet of the BAC; and/or

the three different expansions in step (b) are performed in at least three separate turbines.

In another embodiment, the method for the liquefaction of the industrial gas can include the steps of: a) withdrawing a pressurized natural gas stream from a natural gas pipeline; b) sending a first portion of the pressurized natural gas stream to a methanol production facility under conditions effective for producing a methanol stream, a purified hydrogen stream, and a purge gas rich in hydrogen; c) providing a first portion of cooling by expanding a second portion of the pressurized natural gas stream; d) providing a second portion of cooling by expanding the purge gas rich in hydrogen; e) providing a third portion of cooling by expanding a first portion of a pressurized air gas stream from or derived from an air separation unit (ASU), wherein the air gas from or derived from an ASU is a gas stream selected from the group consisting of compressed and purified air from a booster air compressor, a nitrogen stream from a nitrogen pipeline, and combinations thereof; f) cooling the industrial gas in a heat exchanger using the first portion of cooling and the second portion of cooling; and g) further cooling and liquefying the industrial gas in the heat exchanger using the third portion of cooling to produce a liquefied industrial gas.

In optional embodiments of the method for the liquefaction of the industrial gas:

the third portion of cooling is provided at colder temperatures than both the first portion of cooling and the second portion of cooling;

the industrial gas is cooled to a temperature warmer than about −140° C. in step f); and/or

the industrial gas is cooled to a temperature between −140° C. to −165° C. in step g).

As noted supra, the typical methanol process described above includes at least two streams: high pressure natural gas letdown to fuel and hydrogen rich purge as letdown as fuel, which do not utilize the high pressure energy available. In certain embodiments, the potential high pressure energy of these two streams may be utilized by expansion of the two streams in conjunction with expansion of a third pressurized gas stream originating from an ASU for refrigeration purposes.

In one embodiment, at least a portion of the natural gas and the hydrogen rich purge streams are diverted to an exchanger where they are cooled down, then expanded in turbines to extract energy and produce colder process streams which are then re-warmed in the exchanger to cool the turbine inlet streams as well as the fluid to be liquefied (e.g. natural gas, ethane, methane, nitrogen, hydrogen, ethylene, etc . . . ).

The third source of refrigeration can be provided by expansion of a pressurized gas stream originating from an ASU selected from the group consisting of air from the discharge of the main air compressor (MAC) following purification, nitrogen coming from the medium pressure column after warming in the ASU heat exchanger, and combinations thereof. Alternatively, the withdrawal location of the medium pressure air from the ASU may be partially cooled from the discharge of the ASU heat exchanger and/or the location of the nitrogen may be partially cooled from the inlet of ASU heat exchanger.

During operation of an ASU, it is typical for the MAC to be operating at below its maximum design condition. This is because the maximum design conditions are often based on worst case conditions (e.g., maximum liquid products, maximum high pressure gaseous oxygen, summer conditions, etc . . . ), which may be occasionally required but are rarely an actual operating point. Additionally, the design capacities of the major equipment such as MAC and BAC can be maximized to the limit of a step change in capital cost, for example based on the limit of a compressor frame size.

Additionally, in some cases, the MAC can be used to provide additional air to the front end purification unit during the repressurization step of the regeneration cycle. As the repressurization step only occurs for a small portion of the overall purification cycle of the front end purification unit, the MAC is operating at below maximum capacity for the majority of the time. Therefore, in a typical air separation unit, there is often excess capacity available from the MAC and pretreatment such that high pressure air can be withdrawn from the ASU at approximately 4-40 bara with some operating cost but with little or zero additional capital cost.

Therefore, certain embodiments of the invention provide for an improved process for liquefaction of an industrial gaseous stream, for example natural gas, that incorporates the available wasted energy of these two processes in an efficient manner.

In one embodiment, a method for the liquefaction of an industrial gas selected from the group consisting of natural gas, nitrogen, and combinations thereof, is provided. In one embodiment, the method can include the steps of: a) withdrawing a pressurized natural gas stream from a natural gas pipeline; b) removing carbon dioxide and water from the pressurized natural gas stream; c) expanding the pressurized natural gas stream to form an expanded natural gas stream and warming the expanded natural gas stream in a first portion of a heat exchanger against the industrial gas to form a warmed natural gas stream; d) sending the warmed natural gas stream to a methanol production facility under conditions effective for producing a methanol stream, a purified hydrogen stream, and a purge gas rich in hydrogen; e) expanding the purge gas rich in hydrogen to form an expanded purge gas and warming the expanded purge gas in a second portion of the heat exchanger against the industrial gas to form a warmed purge gas stream; f) sending the warmed purge gas stream to the methanol production facility for use as fuel; and g) expanding a pressurized air gas stream from or derived from an air separation unit (ASU) to form an expanded air gas stream and warming the expanded air gas stream in a third portion of the heat exchanger against the industrial gas to form a warmed air gas stream, wherein the industrial gas is liquefied during step g).

In optional embodiments of the method for the liquefaction of the industrial gas:

the air gas from or derived from an ASU is a gas stream selected from the group consisting of compressed and purified air from a main air compressor, a nitrogen stream from a medium pressure column, and combinations thereof;

the industrial gas further comprises trace components having a freezing point temperature warmer than that of methane, wherein the first portion of the heat exchanger and the second portion of the heat exchanger are kept at temperatures warmer than the freezing point temperature of the trace components, and wherein the trace components are removed from the industrial gas prior to the industrial gas being cooled in the third portion of the heat exchanger; and/or

the third portion of cooling is provided at colder temperatures than both the first portion of cooling and the second portion of cooling.

In another embodiment, the method for the liquefaction of the industrial gas can include the steps of: (a) providing a pressurized natural gas stream, a pressurized purge gas stream originating from a methanol plant, and a pressurized air gas stream comprising an air gas from an air separation unit (ASU), wherein the pressurized purge gas stream is comprised predominately of hydrogen, wherein the pressurized air gas stream has an oxygen concentration at or below that of atmospheric air; (b) expanding three different pressurized gases to produce three cooled streams, wherein the three different pressurized gases consist of the pressurized natural gas stream, the pressurized purge gas stream, and the pressurized air gas stream; and (c) liquefying the industrial gas in a liquefaction unit against the three cooled streams to produce a liquefied industrial gas stream, wherein the industrial gas to be liquefied is selected from the group consisting of a first portion of the pressurized natural gas stream, a nitrogen gas stream from a nitrogen pipeline, and combinations thereof.

In optional embodiments of the method for the liquefaction of the industrial gas:

the air gas from an ASU is a gas stream selected from the group consisting of compressed and purified air from a main air compressor, a nitrogen stream originating from a medium pressure column of the ASU, and combinations thereof, wherein the air gas from the ASU is at a pressure between 4 and 40 bara;

the pressurized natural gas stream comprises methane and trace components, wherein the trace components have freezing point temperatures warmer than that of methane;

the trace components have a freezing point temperature warmer than about 140° C.;

in steps (b) and (c): the pressurized natural gas stream provides a first portion of cooling to the industrial gas, the pressurized purge gas stream provides a second portion of cooling to the industrial gas, and the pressurized air gas stream provides a third portion of cooling to the industrial gas, wherein the third portion of the cooling is at a temperature that is colder than the first portion of the cooling and the second portion of the cooling;

the pressurized air gas stream further comprises nitrogen gas from a nitrogen pipeline;

at least a portion of the air gas of the pressurized air gas stream is withdrawn at a location downstream a main air compressor (MAC) of the ASU at or slightly below an outlet pressure of the MAC;

the flow of the air gas of the pressurized air gas stream withdrawn from the outlet of the MAC and provided in step (a) is only withdrawn during periods wherein there is no repressurization step taking place within a front end purification unit of the ASU;

the flow of the air gas of the pressurized air gas stream withdrawn from the outlet of the MAC and provided in step (a) accounts for less than about 20% of the total volumetric flow of air coming from the outlet of the MAC, and more preferably accounts for less than about 5% of the total volumetric flow of air coming from the outlet of the MAC; and/or

the three different expansions in step (b) are performed in at least three separate turbines.

In another embodiment, the method for the liquefaction of the industrial gas can include the steps of: a) withdrawing a pressurized natural gas stream from a natural gas pipeline; b) sending a first portion of the pressurized natural gas stream to a methanol production facility under conditions effective for producing a methanol stream, a purified hydrogen stream, and a purge gas rich in hydrogen; c) providing a first portion of cooling by expanding a second portion of the pressurized natural gas stream; d) providing a second portion of cooling by expanding the purge gas rich in hydrogen from step b); e) providing a third portion of cooling by expanding a first portion of a pressurized air gas stream from or derived from an air separation unit (ASU), wherein the air gas from or derived from an ASU is a gas stream selected from the group consisting of compressed and purified air from a main air compressor, a nitrogen stream from a medium pressure column, and combinations thereof; f) cooling the industrial gas in a heat exchanger using the first portion of cooling and the second portion of cooling; and g) further cooling and liquefying the industrial gas in the heat exchanger using the third portion of cooling to produce a liquefied industrial gas.

In optional embodiments of the method for the liquefaction of the industrial gas:

the third portion of cooling is provided at colder temperatures than both the first portion of cooling and the second portion of cooling;

the third portion of the pressurized natural gas stream is cooled to a temperature warmer than about −140° C. in step f); and/or

the third portion of the pressurized natural gas stream is cooled to a temperature between −140° C. to −165° C. in step g).

In another embodiment, the method for the liquefaction of the industrial gas can include the steps of: a) withdrawing a pressurized natural gas stream from a natural gas pipeline; b) sending a first portion of the pressurized natural gas stream In certain embodiments of the invention, a method is provided for liquefying a pressurized hydrogen gas by using the letdown energy previously being wasted. In certain embodiments, the letdown energy can be provided by letdown of a high pressured gas selected from the group consisting of (1) a natural gas stream from a high pressure natural gas pipeline, (2) a nitrogen gas stream from a high pressure nitrogen pipeline, (3) a hydrogen gas stream from a nearby facility, and combinations thereof.

In an optional embodiment, the high pressured gas can further include a dry and purified air gas from or derived from an air separation facility, wherein the dried and purified air gas is selected from the group consisting of pressurized air from a main air compressor, pressurized air from a booster air compressor, pressurized nitrogen from a medium pressure column, and combinations thereof.

In certain embodiments, a process is provided that optimally utilizes the natural gas letdown energy while accommodating the system fluctuations. A typical small scale LNG scheme utilizes a nitrogen cycle (N₂ recycle compressor and two turbine boosters) in a closed loop. However, certain embodiments of the present invention present flexible solutions that enable full utilization of the letdown energy by combining natural gas turbo-expansion for natural gas pre-cooling and a refrigeration cycle. Therefore, even when the letdown capacity varies, the production can be maintained while reducing costs. In certain embodiments of the invention, the refrigeration cycle used is either a nitrogen refrigeration cycle or a mixed refrigerant refrigeration cycle.

In one embodiment of the present invention, a method for the liquefaction of natural gas is provided. In one embodiment, the method can include the steps of: a) withdrawing a pressurized natural gas stream from a natural gas pipeline; b) boosting a first portion of the pressurized natural gas stream to a higher pressure using a first natural gas booster to produce a boosted pressurized natural gas stream; c) expanding a first portion of the boosted pressurized natural gas stream in a first natural gas turbine to form a first expanded natural gas stream; d) warming the first expanded natural gas stream in a heat exchanger against a second portion of the boosted pressurized natural gas stream to produce a first warmed natural gas stream; e) expanding a second portion of the pressurized natural gas stream in a second natural gas turbine to form a second expanded natural gas stream; f) warming the second expanded natural gas stream in the heat exchanger against the second portion of the boosted pressurized natural gas stream to produce a second warmed natural gas stream; and g) liquefying the second portion of the boosted pressurized natural gas stream in the heat exchanger using refrigeration provided from a refrigeration cycle to form a liquefied natural gas (LNG) product.

In optional embodiments of the invention:

the first natural gas turbine is configured to power the first natural gas booster;

the second natural gas turbine is configured to power a generator such that electricity is produced during step f);

the second natural gas turbine is configured to power a second natural gas booster;

the refrigeration cycle comprises a refrigerant by-pass configured to remove a portion of refrigerant coolant from an intermediate section of the heat exchanger thereby reducing the amount of cooling provided from the refrigeration cycle to the second portion of the boosted pressurized natural gas stream;

the first warmed natural gas stream and the second warmed natural gas stream are combined within the heat exchanger or combined before entering the heat exchanger;

the method can further include the steps of: removing carbon dioxide and water from the pressurized natural gas stream using an adsorption bed; and regenerating the adsorption bed using a low pressure natural gas, wherein the low pressure natural gas is selected from the group consisting of the first warmed natural gas stream, the second warmed natural gas stream, and combinations thereof;

the first expanded natural gas stream and the second expanded natural gas stream are expanded to about the same pressure;

the method can further include the steps of: sending a flow of a low pressure natural gas to a user; adjusting the amount of the second portion of the pressurized natural gas stream expanded in the second natural gas turbine based on the flow of the low pressure natural gas sent to the user, wherein the low pressure natural gas is selected from the group consisting of the first warmed natural gas stream, the second warmed natural gas stream, and combinations thereof;

the amount of LNG product produced in step h) is unchanged by the amount of the second portion of the pressurized natural gas stream expanded in a second natural gas turbine in step f);

the pressure of the second portion of the boosted pressurized natural gas stream during liquefaction is unchanged by the combined flow rate of the first expanded natural gas stream and the second expanded natural gas stream;

the method can further include the steps of: modifying the amount of the second portion of the pressurized natural gas stream expanded in the second natural gas turbine in step f); and adjusting the refrigeration provided from the refrigeration cycle to the second portion of the boosted pressurized natural gas stream in step h) in order to keep the amount of the LNG product produced within a targeted range;

the refrigeration cycle is selected from the group consisting of a nitrogen refrigeration cycle and a mixed refrigerant refrigeration cycle;

the refrigeration cycle has only one turbine-booster; and/or

the nitrogen cycle comprises two turbine-boosters.

In one embodiment of the present invention, a method for the liquefaction of natural gas is provided. In one embodiment, the method can include the steps of: a) withdrawing a pressurized natural gas stream from a natural gas pipeline operating at a first pressure; b) boosting a first portion of the pressurized natural gas stream in a first natural gas booster to a second pressure to produce a boosted pressurized natural gas stream; c) expanding a first portion of the boosted pressurized natural gas stream in a first natural gas expansion turbine to a third pressure to produce a first expanded natural gas stream; d) liquefying a second portion of the boosted pressurized natural gas stream in a natural gas liquefier using refrigeration provided by a refrigeration cycle; e) expanding a second portion of the pressurized natural gas stream in a second expansion turbine to a fourth pressure to produce a second expanded natural gas stream; f) warming the first expanded natural gas stream and the second expanded natural gas stream by in-direct heat exchange against the second portion of the boosted natural gas stream to produce a first and second warmed expanded natural gas stream; g) sending the first and second warmed expanded natural gas stream to a downstream facility, wherein the downstream facility has a natural gas demand, wherein the first natural gas expansion turbine is configured to provide compression power for the first natural gas booster.

In optional embodiments of the invention:

the flow rate of the second portion of the pressurized natural gas stream expanded in the second expansion turbine is adjusted based on changes in the natural gas demand of the downstream facility;

the flow rate of the second portion of the boosted pressurized natural gas stream is independent of the natural gas demand of the downstream facility; and/or

the method can further include the step of monitoring the first pressure; and adjusting the flow rates of the first portion of the boosted pressurized natural gas stream and the second portion of the pressurized natural gas stream based on the first pressure while maintaining the flow rate of the LNG stream produced in step d).

In another embodiment of the present invention, a method for the liquefaction of natural gas is provided. In one embodiment, the method can include the steps of: a) boosting a first pressurized natural gas stream to a higher pressure using a first natural gas booster to produce a boosted pressurized natural gas stream; b) expanding a second pressurized natural gas stream in a first natural gas turbine to form a first expanded natural gas stream; c) warming the first expanded natural gas stream in a heat exchanger against a second portion of the boosted pressurized natural gas stream to produce a first warmed natural gas stream; d) expanding a third pressurized natural gas stream in a second natural gas turbine to form a second expanded natural gas stream; e) warming the second expanded natural gas stream in the heat exchanger against the second portion of the boosted pressurized natural gas stream to produce a second warmed natural gas stream; and f) liquefying the second portion of the boosted pressurized natural gas stream in the heat exchanger using refrigeration provided from a refrigeration cycle to form a liquefied natural gas (LNG) product, wherein the first pressurized natural gas stream, the second pressurized natural gas stream, and the third pressurized natural gas stream all originate from a common high pressure natural gas pipeline.

In another embodiment of the present invention, a method for the liquefaction of natural gas is provided. In one embodiment, the method can include the steps of: a) expanding a first pressurized natural gas stream in a first natural gas turbine to form a first expanded natural gas stream; b) warming the first expanded natural gas stream in a heat exchanger against a second pressurized natural gas stream to produce a first warmed natural gas stream; c) expanding a third pressurized natural gas stream in a second natural gas turbine to form a second expanded natural gas stream; d) warming the second expanded natural gas stream in the heat exchanger against the second pressurized natural gas stream to produce a second warmed natural gas stream; and e) liquefying the second portion of the boosted pressurized natural gas stream in the heat exchanger using refrigeration provided from a refrigeration cycle to form a liquefied natural gas (LNG) product, wherein the first natural gas turbine is configured to drive a first booster, wherein the first booster is configured to compress a stream selected from the group consisting of the first pressurized natural gas stream, the first warmed natural gas stream, the second pressurized natural gas stream.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 provides an embodiment of the present invention.

FIG. 2 provides an additional embodiment of the present invention.

FIG. 3 provides yet another embodiment of the present invention.

FIG. 4 shows an embodiment of the present invention.

FIG. 5 shows an embodiment of the air separation unit and nitrogen pipeline in accordance with an embodiment of the present invention.

FIG. 6 shows an embodiment of a methanol production facility in accordance with an embodiment of the present invention.

FIG. 7 shows an embodiment of an integrated methanol production facility with an ASU and liquefier in accordance with an embodiment of the present invention.

FIG. 8 shows an embodiment of the present invention.

FIG. 9 shows a second embodiment of the present invention.

FIG. 10 shows an embodiment of the air separation unit and nitrogen pipeline in accordance with an embodiment of the present invention.

FIG. 11 shows an embodiment of a methanol production facility in accordance with an embodiment of the present invention.

FIG. 12 shows an embodiment of an integrated methanol production facility with an ASU and liquefier in accordance with an embodiment of the present invention.

FIG. 13 shows an embodiment of an integrated methanol production facility with an ASU and liquefier in accordance with an embodiment of the present invention.

FIG. 14 shows another embodiment of an integrated methanol production facility with an ASU and liquefier in accordance with an embodiment of the present invention.

FIG. 15 shows an embodiment of a hydrogen liquefier in accordance with an embodiment of the present invention.

FIG. 16 shows another embodiment of a hydrogen liquefier in accordance with an embodiment of the present invention.

FIG. 17 shows another embodiment of a hydrogen liquefier in accordance with an embodiment of the present invention.

FIG. 18 shows an embodiment of an integrated methanol production facility with an ASU and liquefier in accordance with an embodiment of the present invention.

FIG. 19 shows an embodiment of the prior art.

FIG. 20 shows an embodiment in accordance with the present invention.

FIG. 21 shows a second embodiment in accordance with the present invention.

FIG. 22 shows a third embodiment in accordance with the present invention.

FIG. 23 shows yet another embodiment in accordance with the present invention.

### DETAILED DESCRIPTION

While the invention will be described in connection with several embodiments, it will be understood that it is not intended to limit the invention to those embodiments. On the contrary, it is intended to cover all the alternatives, modifications and equivalence as may be included within the spirit and scope of the invention defined by the appended claims.

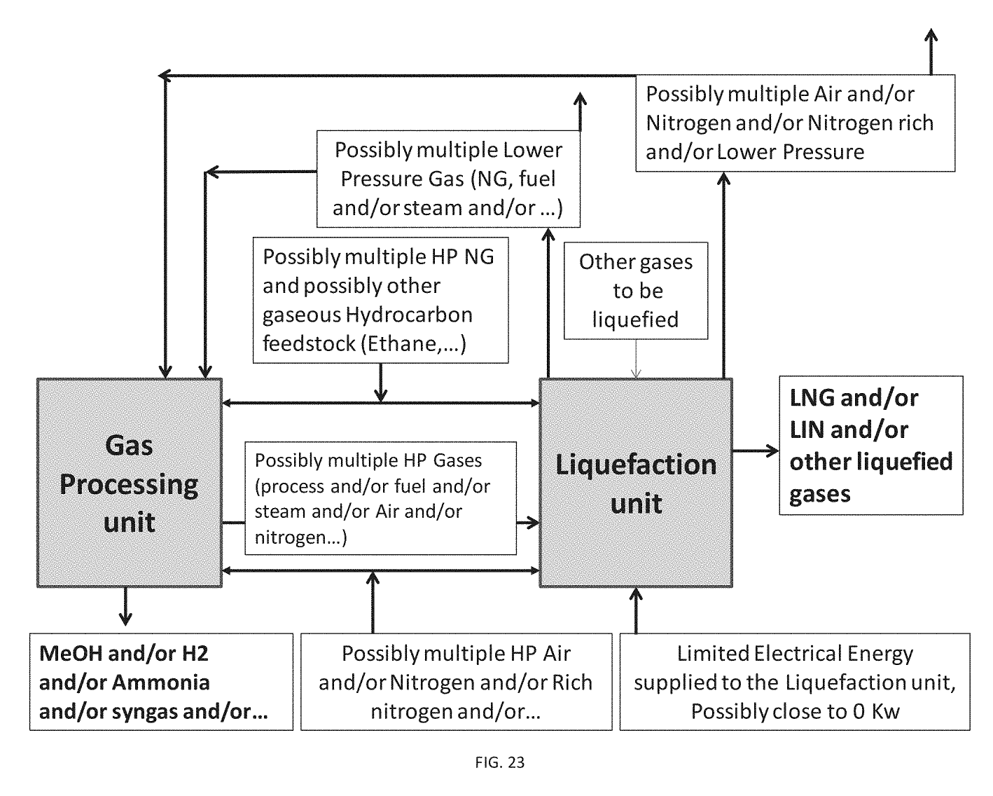

As shown in FIG. 23, it is proposed to integrate a gas processing unit with a liquefaction unit. There is a demand to reduce the cost of liquefying an industrial gas stream. The industrial gas stream may be but is not limited to air gases of oxygen, nitrogen argon, hydrocarbon, LNG, syngas or its components, CO2, or any other molecule or combination of molecules. It is proposed to integrate the underutilized process inefficiencies of a gas processing unit into the liquefaction unit to produce a liquid at a reduced operating cost. The gas processing unit may be any system or apparatus which alters the composition of a feed gas. Examples could be but is not limited to a methanol plant, steam methane reformer, Cogen, partial oxidation unit.

More specifically, the integration of one or multiple high pressure natural gas and possibly other gaseous hydrocarbon feedstock (Ethane, etc . . . ) sent to the liquefier and/or the GPU, reducing the pressure to extract energy and exiting as a lower pressure stream to be utilized in the GPU at the optimum utilization pressure. Similarly, multiple HP Air and/or Nitrogen and/or Rich nitrogen and/to other gas stream may be sent to the liquefier and/or the GPU, reducing the pressure to extract energy and exiting as a lower pressure stream to be utilized in the GPU at the optimum utilization pressure.

The energy extracted from the pressure letdown streams above may be used to provide refrigeration for the counter current heat exchange with the gas to be liquefied.

In one embodiment, the method can include integrating a natural gas letdown system with a refrigeration cycle (e.g., nitrogen, mixed refrigerant) and a syngas production facility. In one embodiment, the refrigeration cycle is a closed loop refrigeration cycle. In this embodiment, the natural gas letdown essentially provides “free” refrigeration energy since the natural gas would have been alternatively letdown across a valve (i.e., the resulting drop in temperature of the natural gas would have been absorbed by the surroundings and would not have been recovered in any meaningful way). With the addition of a natural gas turbine booster, LNG can be co-produced with a significant power savings, while also potentially reducing the size of the nitrogen refrigeration cycle. In another embodiment, a purification unit, storage, loading and utility systems may also be included. In another embodiment, the natural gas that is letdown is provided to a syngas production facility (SPF) (e.g., SMR, ATR, ATR+SMR, etc . . . ), which in turn produces excess steam that is used to drive a steam turbine, which can then power the recycle compressor of the refrigeration cycle.

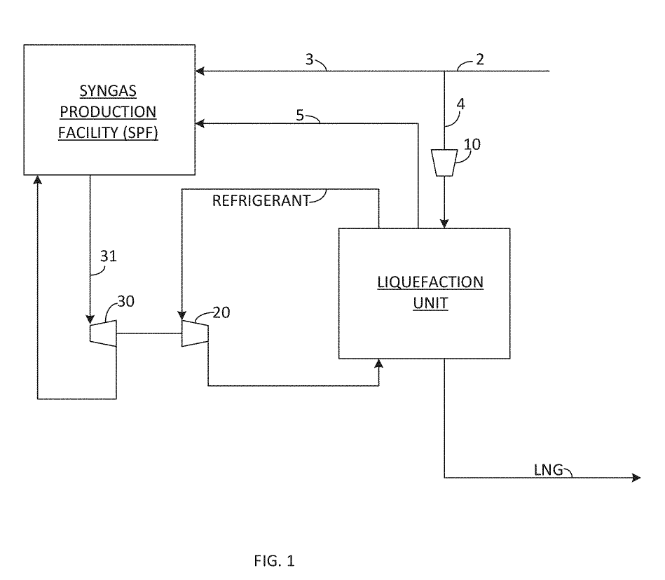

Referring to FIG. 1, a process flow diagram of an embodiment of the current invention is shown. In FIG. 1, high pressure natural gas 2 is preferably split into two portions, with one portion being sent to the syngas production facility (e.g., SMR) for use as process gas 3. Second portion of high pressure natural gas 4 is optionally purified in a purification unit (not shown) in order to remove water and carbon dioxide according to methods known heretofore. Following purification, the second portion 4 can then be pressurized in natural gas compressor 10 prior to being sent to the natural gas liquefaction unit. Within natural gas liquefaction unit, a portion of the natural gas is liquefied to produce LNG. Another portion of natural gas is withdrawn from the liquefaction unit as a low pressure, warm natural gas stream, which is subsequently provided to the SMR for use as fuel 5.

In the embodiment shown, refrigeration for the liquefaction unit is provided by two primary sources. The first source can be a refrigeration cycle in which a refrigerant is compressed in refrigerant recycle compressor 20 before refrigerant is expanded to provide the cold temperature cooling. The second source of refrigeration can be provided by using the excess pressure differential of the high pressure natural gas which is used as fuel in the burners of the SMR.

Advantageously, embodiments of the present invention provide for reduced costs by using at least a portion of the high pressure steam produced by the SMR to turn steam turbine 30, which directly powers refrigerant recycle compressor 20, preferably via a common shaft or gearbox.

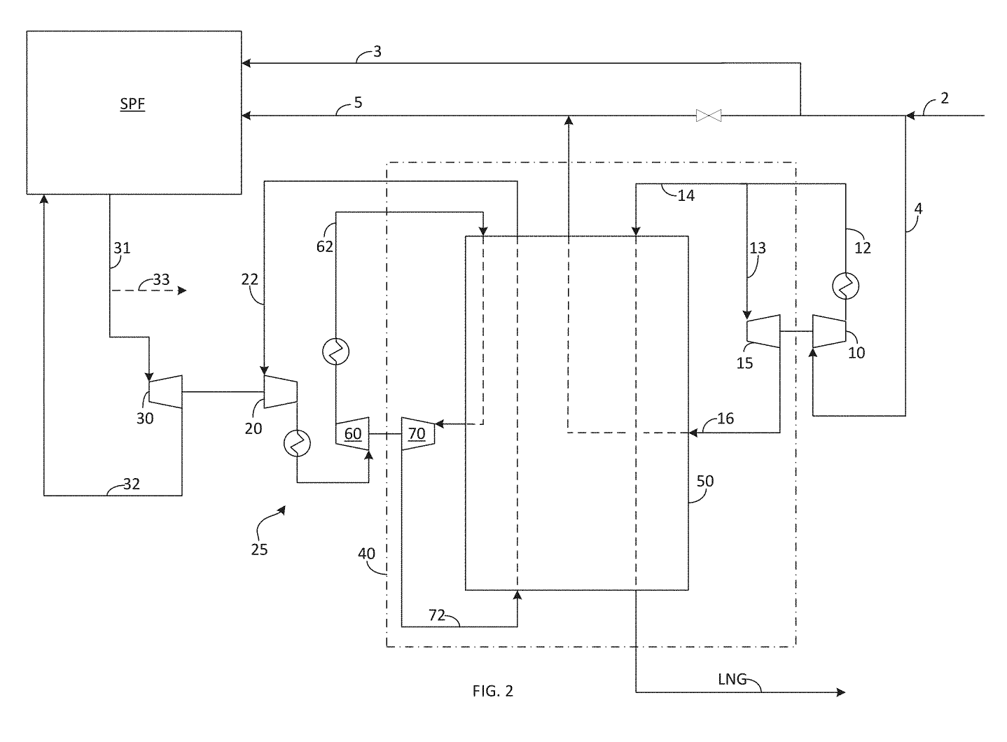

FIG. 2 provides another embodiment of the present invention with more detail pertaining to the liquefaction unit. In this embodiment, high pressure natural gas 2 is again split into process gas 3, which is sent to syngas production facility (SPF), and second portion of high pressure natural gas 4, which is sent to the cold box 40 of liquefaction unit. Second portion of high pressure natural gas 4 can be pressurized in natural gas compressor 10 and cooled in aftercooler to produce second pressurized natural gas stream 12, which can then be split into two streams. First portion 13 can be expanded in natural gas expander 15 to produce expanded natural gas stream 16, which is then warmed in heat exchanger 50 and subsequently sent to the burners of the SMR for use as fuel. Second portion 14 can then be sent to heat exchanger 50 for cooling and liquefying therein to produce LNG product stream. Natural gas expander 15 is preferably connected with natural gas compressor 10 via a common shaft, thereby providing the compressing energy used by natural gas compressor 10.

Refrigeration cycle 25 can include compressing low pressure refrigerant 22 in refrigerant recycle compressor 20 and further boosting in one or more refrigerant boosters 60 to produce pressurized refrigerant. Pressurized refrigerant 62 can then be partially cooled in heat exchanger 50 prior to being expanded in one or more refrigerant expanders 70 to produce expanded refrigerant 72, which is used to provide the cold temperature cooling for the liquefaction unit by exchanging heat with second portion 14 within heat exchanger 50 to produce low pressure refrigerant 22. Refrigerant expander(s) is/are preferably connected with refrigerant booster(s) via a common shaft, thereby providing the compressing energy used by the refrigerant booster(s) 60.

Within the SPF, high pressure steam 31 is produced, which at least a portion can then be used to drive steam turbine 30 to produce low pressure steam 32, which is then recycled back to the SMR. Steam turbine 30 is preferably connected with refrigerant recycle compressor 20 via a common shaft or gear box, thereby providing the compressing energy used by refrigerant recycle compressor 20. In an optional embodiment, a portion of steam 33 can be used for other purposes.

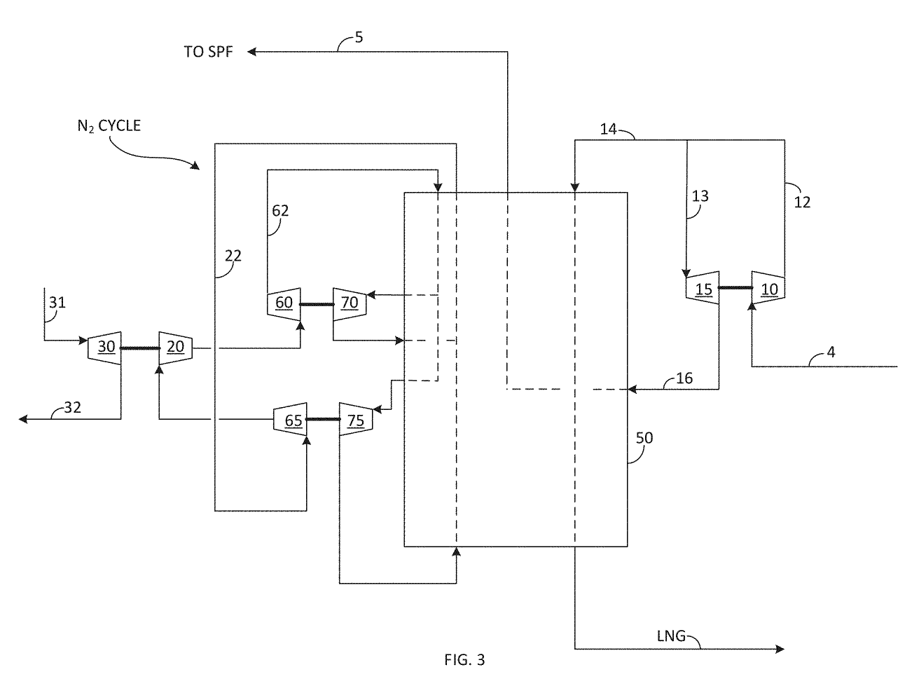

FIG. 3 provides another embodiment of the present invention that includes experimental data. In this embodiment, approximately 23,550 NM³/hr of natural gas at 35 bara is compressed in natural gas compressor 10 to a pressure of about 46 bara. Approximately 6000 NM³/hr is then expanded to about 4 bara in natural gas expander 15 to produce approximately 273 kW of work (which powers natural gas compressor 10). The resulting expanded natural gas is then warmed in heat exchanger 50 and used as fuel in the SMR. The remaining 17,550 NM³/hr of pressurized natural gas is then cooled and liquefied in heat exchanger 50 to produced approximately 329 MTD of LNG at 1.08 bara and −166.5° C. In another embodiment (not shown), the pressurized natural gas may be removed from heat exchanger 50, at an intermediate temperature (e.g., −30° C. to −90° C.) in order to remove the condensed heavy hydrocarbons or NGL production. The remaining vapor can then be reintroduced to heat exchanger 50 at the intermediate point for further cooling and liquefaction.

The cold temperature refrigeration for the system is provided by a nitrogen refrigeration cycle using a flow of 93,000 NM³/hr of nitrogen. The low pressure refrigerant is at about 5.7 bara before it is compressed in first refrigerant compressor 65 to a pressure of about 6.9 bara (by using about 6 MW worth of power from steam turbine 30). From there, the refrigerant is further compressed in refrigerant recycle compressor 20 to a pressure of about 28 bara, and then further compressed in second refrigerant compressor 60 to a pressure of about 48 bara. From there, the pressurized refrigerant is partially cooled in heat exchanger 50, and split into two streams that are then expanded in first and second refrigerant expanders 70, 75, which are used to power first and second refrigerant compressors 60 (2094 kW), 65 (691 kW), respectively. Following expansion, the produced cold refrigerant streams are reintroduced to the heat exchanger 50 to provide refrigeration therein for liquefaction of the natural gas.

In the embodiment shown, zero external energy is used to power the compressors (10, 20, 70, 75). This results in a significant cost savings over those methods and systems described in the prior art. For example, in methods known heretofore, steam turbine 30 would drive an electric generator such that electricity is produced to the electrical grid from the steam letdown. This requires an expensive electrical system and often a low value for the electricity produced.

Those of ordinary skill in the art will recognize that other types of refrigeration cycles may be used. Therefore, embodiments of the invention are not intended to be limited to the particular refrigeration cycles shown and described within the detailed specification and in the accompanying figures. For example, the arrangement of compressors 20, 60, and 65 may be such that compressor 20 is located either before or after both compressors 60 and 65. Alternatively nitrogen refrigeration cycle 25 may be replaced by a mixed refrigerant cycle without turbine boosters 70-60, and 75-65.

In one embodiment, it is proposed to utilize the potential high pressure energy of the two streams in the above-described methanol process: 1) high pressure natural gas letdown to fuel and 2) high pressure hydrogen rich purge gas letdown as fuel. At least a portion of these streams can be diverted to an exchanger where they can be cooled down, then expanded in a turbine to extract energy and produce a colder process stream, which is then re-warmed in the exchanger to cool the turbine inlet streams, as well as the fluid to be liquefied (e.g., natural gas for LNG or nitrogen for LIN). For a chosen turbine discharge temperature, the turbine inlet temperature can be a result of the available pressure ratio across the turbine. Therefore, in certain embodiments, the two diverted streams from the methanol process are not cooled down prior to expansion.

Because the natural gas stream and purge gas streams can contain some trace components such as, but not limited to ethane, propane, and butane+, there is a low temperature limit for the turbine discharge to prevent liquid formation, which creates process complexities at low levels and turbine damage at high levels. In certain embodiments, this temperature limit can be in the range of −100° C. depending on composition and pressure. For purposes herein, about −100° C. includes −100° C.+/−30° C. Those of ordinary skill in the art will recognize that this lower level temperature limit for the natural gas stream is preferably selected to prevent adverse process conditions (e.g., excess liquid production) coming out of the turbine discharge. In one embodiment, the molar fraction of liquid at the turbine discharge is less than 20%, preferably less than 15%, more preferably less than 10%. In one embodiment, no liquid production is preferred in the discharge of the turbines.

The liquefaction temperature of low pressure natural gas is approximately −160° C.; therefore, an additional refrigerant is included in embodiments of the present invention in order to liquefy the natural gas at temperatures below the lower limit of the natural gas stream. In one embodiment, the additional refrigerant provides refrigeration in the temperature range from about −100° C. to −160° C. In one embodiment, this additional refrigeration can be provided by expansion of nitrogen and/or air from the ASU. As such, the additional refrigeration can be provided by a stream directly from an ASU and/or from a gas stream derived from an ASU (e.g., nitrogen from a pipeline being a gas stream derived from an ASU).

As described above, the pressurized air from the ASU can be available at approximately 15-100 bara and at relatively low cost due to the typical operating range of the ASU and worst case equipment design basis. With integration of the methanol plant, additional savings can be achieved by driving the MAC and BAC using steam turbines using available steam from the methanol plant.

In another embodiment, a portion of the high pressure air that is not sent to the ASU cold box can be mixed with available high pressure nitrogen (HPN₂) from a nitrogen pipeline at approximately 15-100 bara. This can result in a low-cost, lean synthetic high pressure air (or impure N₂) stream at approximately 15-100 bara to be available for expansion refrigeration in the liquefier. In one embodiment, the air injection may be limited by the combustibility limit of O₂ in methane (approx 12%) or O₂ in H₂ (approx 6%) or by design margin to these limits if there is a potential leak.

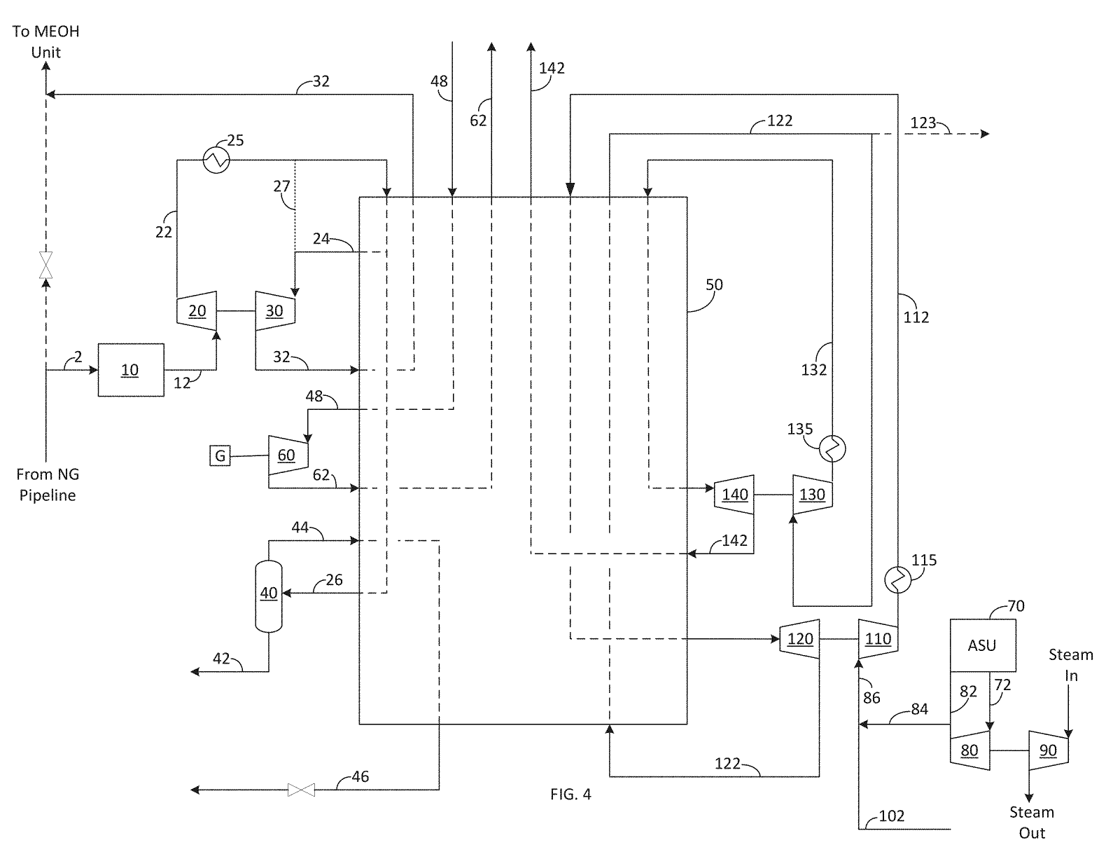

Now turning to FIG. 4. Natural gas 2 is purified of carbon dioxide and water in purification unit 10 to form stream 12 before being compressed in compressor 20 to form pressurized natural gas 22. Pressurized natural gas 22 is then cooled by aftercooler 25 to remove heat of compression from compressor 20.

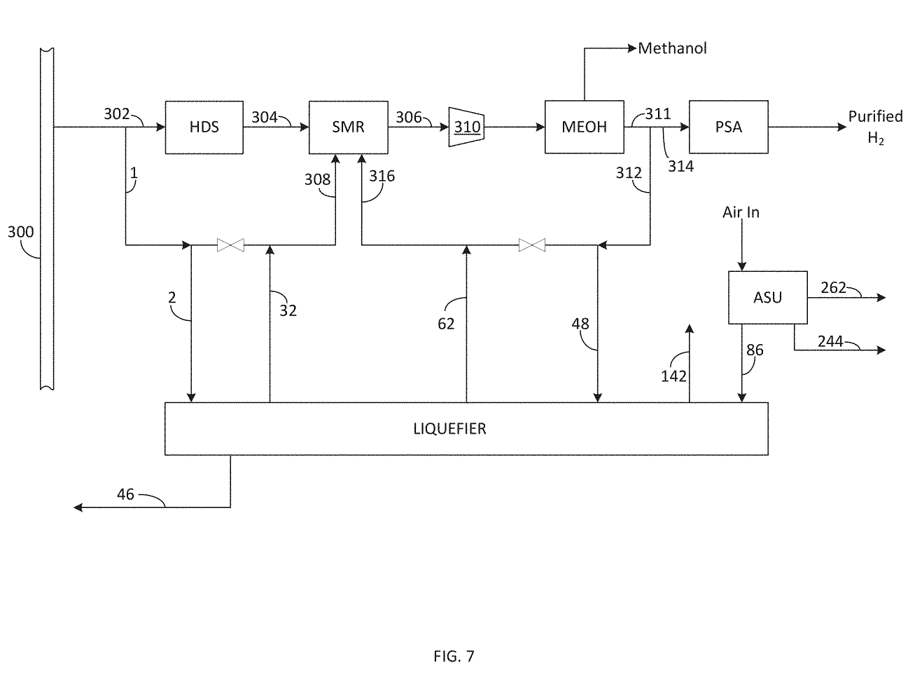

For the warm end refrigeration (i.e., temperatures warmer than about −100° C.), pressurized natural gas 22 is then cooled within heat exchanger 50, wherein a first portion of the pressurized natural gas 24 is withdrawn at a first intermediate point of the heat exchanger where it is expanded in turbine 30 to low pressure to form first expanded portion 32, before being warmed in heat exchanger 50 and subsequently sent to the methanol plant to be used as fuel (see lines 32 and 308 of FIG. 7). Alternatively, after exiting aftercooler 25, the pressurized natural gas may be sent directly to the inlet of turbine 30 via line 27 rather than cooling the gas in exchanger 50 for the purpose of limiting the temperature at the discharge of the turbine. First expanded portion 32 provides a first portion of the refrigeration used to cool and eventually liquefy the natural gas. The turbine 30 can drive a generator or booster to pre-boost the total NG feed as shown, or only the NG to be liquefied, or only the NG to be expanded, or to post-boost the NG which was expanded.

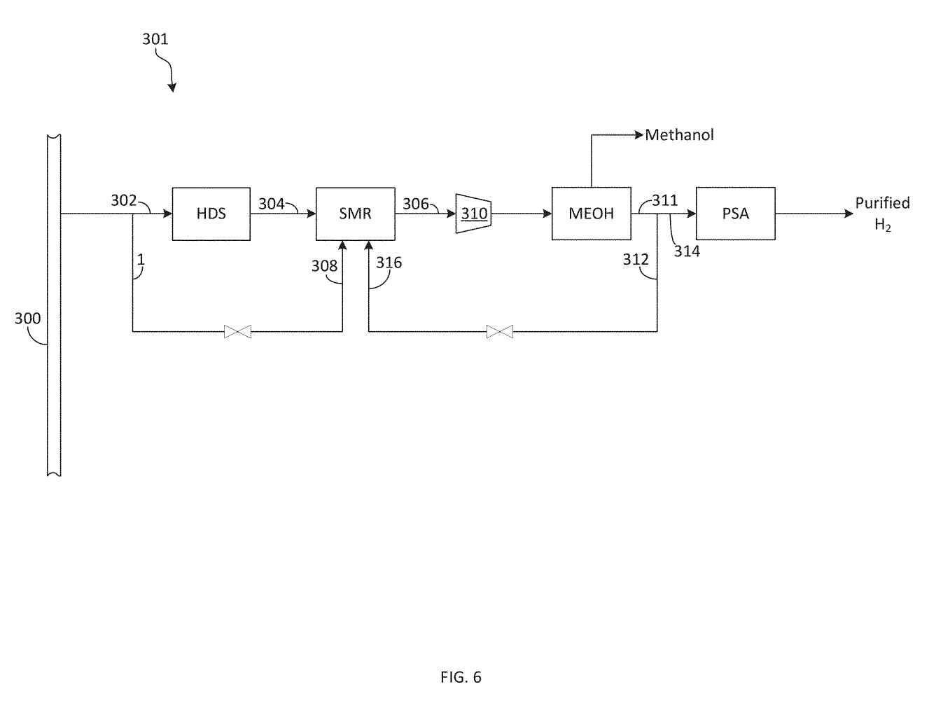

Purge gas 48, which is a high pressure hydrogen rich stream (see 312 of FIG. 6) received from the methanol plant, can be partially cooled (e.g., the purge gas is removed from an intermediate section of the heat exchanger), expanded in second turbine 60 (or set of turbines arranged in series or parallel), which is linked to a generator G, to form expanded purge gas 62 before being warmed in the main exchanger, and sent back to the methanol plant as low pressure fuel (see 316 of FIG. 6). Expanded purge gas 62 provides a second portion of the refrigeration used to cool and eventually liquefy the natural gas.

In another embodiment not shown, after the expanded hydrogen rich purge gas is re-warmed it may be boosted (in a booster which is driven by the expander), re-cooled in the main exchanger, expanded again in a second set of turbines and re-warmed in the main exchanger. This arrangement provides increased refrigeration production by utilizing the higher pressure ratios of the purge gas letdown while at least partially offset by additional cycle complexity and capital cost.

In an optional embodiment, if second portion of the pressurized natural gas 26 (stream to be liquefied as product LNG) contains heavy hydrocarbons such as butane and heavier, it can be withdrawn at a second intermediate point of the heat exchanger and introduced to a liquid/gas separator or distillation column to remove heavy hydrocarbons 42, leaving a top gas 44 that is depleted of heavy hydrocarbons. Top gas 44 is reintroduced into the intermediate and/or cold end of heat exchanger 50, wherein it is further cooled and liquefied to form liquefied natural gas (LNG) 46.

Cold end refrigeration (i.e., temperatures colder than what can be achieved from the purge gas and natural gas expansion or about −100° C. to −140 C) can be provided by a boosted air stream 84, a nitrogen stream 102, or a nitrogen-air mixture 86. In the embodiment shown in FIG. 4, nitrogen-air mixture 86 is used. In the embodiment shown, nitrogen-air mixture 86 is at a high pressure (e.g., approximately 15-100 bara) before being boosted by booster 110, cooled in aftercooler 115 to form high pressure air mixture 112, wherein it is partially cooled in heat exchanger 50, expanded in expander 120 to approximately 6 to 8 bara to form expanded air mixture 122, and then warmed in heat exchanger 50. Expanded air mixture 122 provides a third portion of the refrigeration used to cool and eventually liquefy the natural gas.

In the embodiment shown, expanded air mixture 122, after being warmed in heat exchanger 50, can be boosted in booster 130, cooled in aftercooler 135 to form second boosted air mixture 132, before being partially cooled, expanded in turbine 140 to form second expanded air mixture 142, and then re-warmed thereby providing additional refrigeration and then vented to the atmosphere, used as a dry gas to an evaporative cooling system, or for regeneration within a purification unit.

In one embodiment, second boosted air mixture 132 is at approximately 8-15 bara, and second expanded air mixture 142 is at approximately 1.1-2.0 bara for venting to atmosphere, used as a dry gas to an evaporative cooling system, or recompressed.

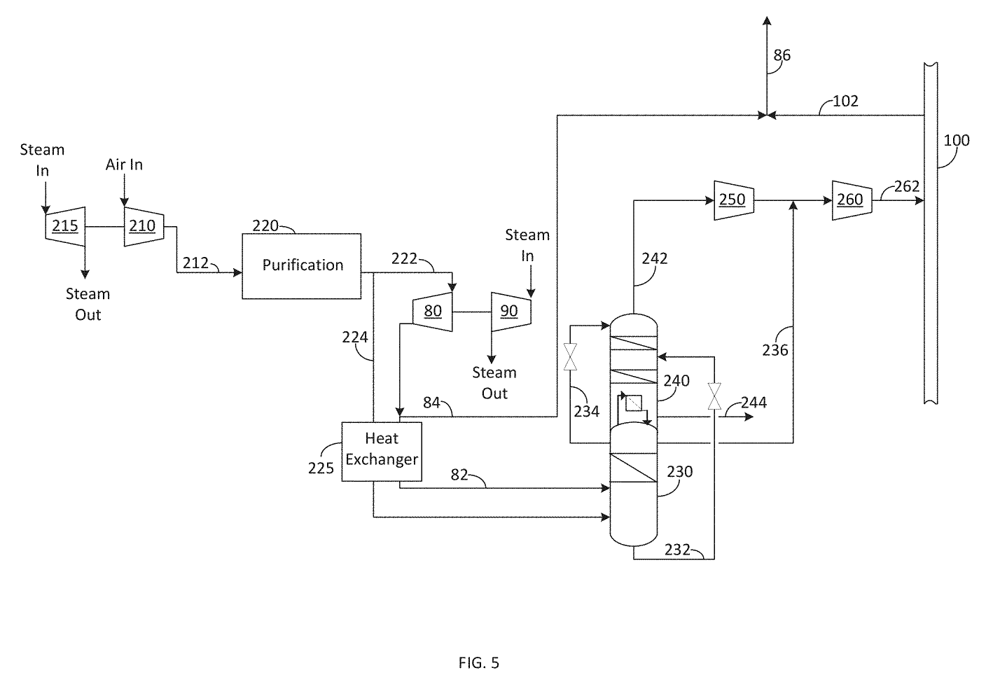

In another embodiment, there may be a requirement for utility nitrogen at a pressure of 5 to 10 bara at the facility, which is typically supplied by the high pressure N₂ pipeline 100 of FIG. 5. In this embodiment, the discharge pressure of expander 120 may be adjusted slightly per the customers demand pressure, such that a portion 123 can be removed as product with the remainder available for boosting in booster 130 and then expanded in the second turbine 140.

In another embodiment, heat exchanger 50 may be split into parallel trains such that there is little to no risk of cold refrigerant leaking and being in contact with the hydrogen rich purge gas stream 48. In this embodiment, the oxygen content in the cold refrigerant 86 can be increased to levels which are above that of the combustibility limits of oxygen in hydrogen (approx 6%).

FIG. 5 provides a schematic representation of an air separation unit in accordance with an embodiment of the invention. Air is compressed in main air compressor (MAC) 210, which can be driven by a motor (not shown) or by steam turbine 215, particularly if excess steam is available, to produce compressed air 212. Compressed air 212 is then purified in purification unit 220 to remove components that will freeze at cryogenic temperatures (e.g., carbon dioxide and water). From there, compressed air 212 can be split into a first portion 222 and a second portion 224, wherein second portion 224 can be cooled in ASU heat exchanger 225 and then introduced to the double distillation column. The first portion 222 is further compressed in booster air compressor (BAC) 80 with a first fraction 82 being cooled in the ASU heat exchanger 225 before being introduced into medium pressure column 230. The remaining boosted air stream 84 is sent to the liquefier as described in FIG. 4, either alone or combined with nitrogen stream 102 from nitrogen pipeline 100 (e.g., nitrogen-air mixture 86).

The double distillation column shown is a typical double distillation column in an air separation unit comprising a lower pressure column 240, a shared condenser/reboiler, and the higher pressure column 230 (sometimes also referred to herein as a medium pressure column). A bottoms liquid 232 rich in oxygen is expanded across a valve before being introduced into lower pressure column 240 for further separation. Nitrogen stream 234 is also introduced as reflux. Liquid oxygen stream 244 is produced at a bottom section of lower pressure column 240 as product or vaporized in ASU heat exchanger 225 for gaseous oxygen production. A low pressure nitrogen stream 242 is produced at the top of low pressure column 240, and medium pressure nitrogen stream 236 is produced at a top portion of higher pressure column 230.

In one embodiment, low pressure nitrogen stream 242 can be further compressed by compressor 250 and combined with medium pressure nitrogen stream 236, and then compressed by compressor 260 to form high pressure nitrogen 262, which can then be introduced to nitrogen pipeline 100. Alternatively, a portion of high pressure nitrogen 262 can be sent directly to the liquefier of FIG. 4 without first going to nitrogen pipeline 100.

FIG. 6 provides a schematic overview of a methanol plant 301. Natural gas is withdrawn from natural gas pipeline 300, with a first portion of the natural gas 302 being sent to a hydro-desulfurization unit to remove sulfur to form a desulfurized natural gas 304. This stream is then sent to a steam methane reformer (SMR) in order to produce syngas 306, which is then pressurized in compressor 310 before being sent to the methanol production facility under conditions effective for producing methanol and a purge gas 311. A first portion of the purge gas 314 is then sent to a pressure swing adsorber (PSA) in order to recover purified hydrogen. In a typical methanol plant, second portion of the purge gas 312, which is at an increased pressure of only nominally less than that of the discharge pressure of compressor 310, is typically expanded across a valve to very low pressure (e.g., about atmospheric pressure) and then sent to the SMR for use as purge gas fuel 316. Similarly, it is typical to supplement this fuel by use of a second portion of the natural gas 1 for use as fuel to the SMR after expansion in a valve via line 308.

FIG. 7 provides a schematic overview of an integrated methanol plant, liquefier and ASU in accordance with an embodiment of the present invention. In embodiments of the present invention, instead of wasting the expansion energy of natural gas 1 and second portion of the purge gas 312 by expansion across a valve, natural gas 2 and purge gas 48 are sent to the liquefier, as described in FIG. 1, in order to provide a portion of the refrigeration used to cool and liquefy the natural gas.

Integration of the methanol plant, liquefier, and ASU provides significant energy savings compared to a stand-alone natural gas liquefier. In one embodiment, all of the refrigeration used for liquefaction of the gas stream is provided by the cooling energy provided from the expansion of the natural gas, purge gas and air gas from the ASU (or nitrogen pipeline), thereby providing liquefaction of the natural gas and/or nitrogen gas with minimal additional compression costs. Alternatively, for increased liquefaction, this liquefaction energy can be supplemented by one or more additional liquefaction energy sources such as a cycle compressor driven by electric, gas turbine, or steam turbine drive.

For example, for a production of approximately 344 mtd LNG, embodiments of the invention can produce that amount of LNG for about 190 kW/mt if free steam is available to drive the air compressor and 235 kW/mt if free steam is not available, whereas a stand-alone LNG plant would produce that amount of LNG for about 660 kW/mt. Clearly, even without free steam, embodiments of the invention provide a significant operational savings.

As used herein, “purge gas stream” is process gas to be withdrawn from the pressurized synthesis process to remove impurities and inerts from the catalytic process. The purge gas from methanol plants typically contains between 50-80% hydrogen.

In one embodiment, it is proposed to utilize the potential high pressure energy of the two streams in the above-described methanol process: 1) high pressure natural gas letdown to fuel and 2) high pressure hydrogen rich purge gas letdown as fuel. At least a portion of these streams can be diverted to an exchanger where they can be cooled down, then expanded in a turbine to extract energy and produce a colder process stream, which is then re-warmed in the exchanger to cool the turbine inlet streams, as well as the fluid to be liquefied (e.g., natural gas for LNG or nitrogen for LIN). For a chosen turbine discharge temperature, the turbine inlet temperature can be a result of the available pressure ratio across the turbine. Therefore, in certain embodiments, the two diverted streams from the methanol process are not cooled down prior to expansion.

Because the natural gas stream and purge gas streams can contain some trace components such as, but not limited to ethane, propane, and butane+, there is a low temperature limit for the turbine discharge to prevent liquid formation, which creates process complexities at low levels and turbine damage at high levels. In certain embodiments, this temperature limit can be in the range of −100° C. depending on composition and pressure. For purposes herein, about −100° C. includes −100° C.+/−30° C. Those of ordinary skill in the art will recognize that this lower level temperature limit for the natural gas stream is preferably selected to prevent adverse process conditions (e.g., excess liquid production) coming out of the turbine discharge. In one embodiment, the molar fraction of liquid at the turbine discharge is less than 20%, preferably less than 15%, more preferably less than 10%. In one embodiment, no liquid production is preferred in the discharge of the turbines.

The liquefaction temperature of low pressure natural gas is approximately −160° C.; therefore, an additional refrigerant is included in embodiments of the present invention in order to liquefy the natural gas at temperatures below the lower limit of the natural gas stream. In one embodiment, the additional refrigerant provides refrigeration in the temperature range from about −100° C. to −160° C. In one embodiment, this additional refrigeration can be provided by expansion of nitrogen and/or air from the ASU. As such, the additional refrigeration can be provided by a stream originating from an ASU and/or from a gas stream derived from an ASU (e.g., nitrogen from a pipeline being a gas stream derived from an ASU).

Oxygen and nitrogen are separated from atmospheric air by cryogenic distillation. The required separation energy is provided by a main air compressor (MAC). Air at approximately 6 bara from the MAC is purified to remove H₂O and CO₂ for cryogenic processing in the medium pressure (MP) column (sometimes also referred to as higher pressure (HP) column). The air flows upward in the MP column as it is enriched in nitrogen and is then condensed by heat exchange against vaporizing liquid oxygen in the LP column. At least a portion of this condensed nitrogen provides the reflux needed for the medium pressure (MP) distillation column. During operation of a typical double column, a portion of the pure nitrogen stream can be withdrawn from the MP column and sent to the top of the lower pressure (LP) column to provide reflux for the LP column. These nitrogen rich reflux streams for the MP and LP columns are used to separate the oxygen from nitrogen or “wash down” the oxygen. This reflux is often in excess of what is required for efficient distillation. For example, a portion of the nitrogen at the top of the MP column can be removed as product without significantly reducing the distillation recoveries (>99% O2 recovery can still be achieved).

This product nitrogen, which has been removed from the MP column, is often valorized by injecting at an intermediate stage of a nitrogen product compressor in order to reduce the nitrogen compression energy compared to a nitrogen compressor with only a low pressure feed.

For air separation plants where this potential for medium pressure N₂ is not valorized as described above, there is an opportunity to utilize this medium pressure nitrogen compression energy directly in an external liquefier.

As described above, the pressurized air from the MAC of the ASU can be available at approximately the operating pressures of the MP column (e.g., 4 to 7 bara) and at relatively low cost due to the typical operating range of the ASU and worst case equipment design basis. Moreover, with integration of the methanol plant, additional savings can be achieved by driving the MAC and BAC using steam turbines with available steam from the methanol plant. In certain embodiments, the MAC and purification unit operate at higher pressures (10 to 40 bara) such that refrigeration for the ASU is provided by pressure letdown through a turbine to the MP column operating at 4-7 bara.

In another embodiment, a portion of the high pressure air that is not sent to the ASU cold box can be mixed with available medium pressure nitrogen (MPN₂) from the MP column if the MPN₂ is not being valorized in the nitrogen compressor. This can result in a low-cost, lean synthetic medium pressure air (or impure N₂) stream in the range of 4-7 bara to be available for expansion refrigeration in the liquefier. In one embodiment, the air injection may be limited by the combustibility limit of O₂ in methane (approx 12%) or O₂ in H₂ (approx 6%) or by design margin to these limits if there is potential leak.

Now turning to FIG. 1. Natural gas 2 is purified of carbon dioxide and water to form stream 12 before being compressed in compressor 20 to form pressurized natural gas 22. Pressurized natural gas 22 is then cooled by aftercooler 25 to remove heat of compression from compressor 20.

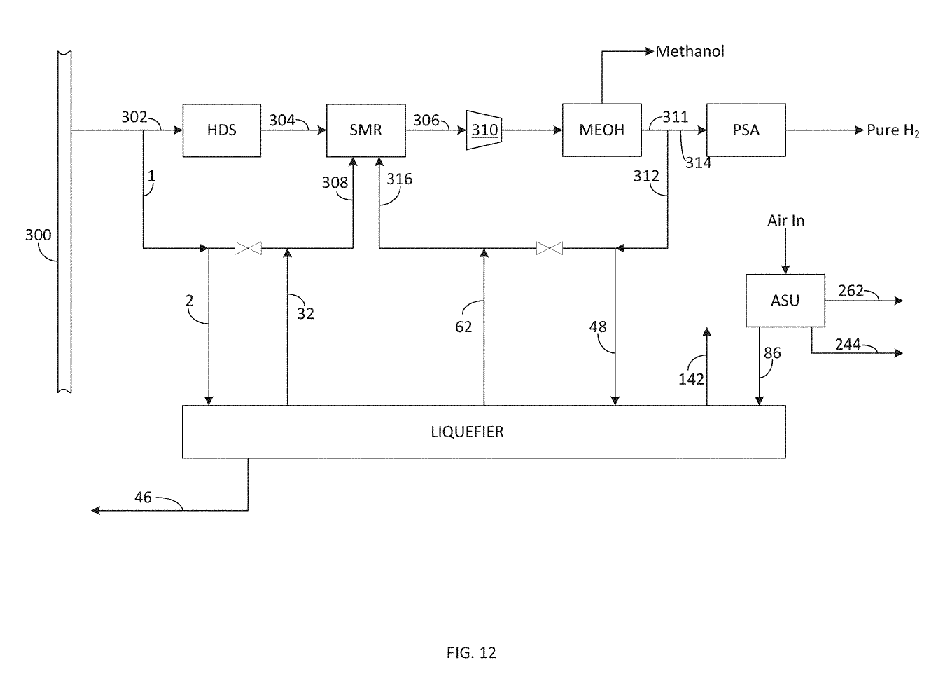

For the warm end refrigeration (i.e., cold temperatures that are still warm enough to prevent freezing of trace components in the natural gas and high pressure purge gas, which in some embodiments is considered to be temperatures warmer than about −100° C. to −140° C.), pressurized natural gas 22 is then cooled within heat exchanger 50, wherein a first portion of the pressurized natural gas 24 is withdrawn at a first intermediate point of the heat exchanger where it is expanded in turbine 30 to low pressure to form first expanded portion 32, before being warmed in heat exchanger 50 and subsequently sent to the methanol plant to be used as fuel (see lines 32 and 308 of FIG. 12). Alternatively, after exiting aftercooler 25, the pressurized natural gas may be sent directly to the inlet of turbine 30 via line 27 rather than cooling the gas in exchanger 50 for the purpose of limiting the temperature at the discharge of the turbine. Alternatively, cooler 25 may be reduced or removed to further warm stream 32.

First expanded portion 32 provides a first portion of the refrigeration used to cool and eventually liquefy the industrial gas, which in the embodiment shown is natural gas. The turbine 30 can drive a generator or booster to pre-boost the total natural gas feed as shown, or only the natural gas to be liquefied, or only the natural gas to be expanded, or to post-boost the natural gas which was expanded.

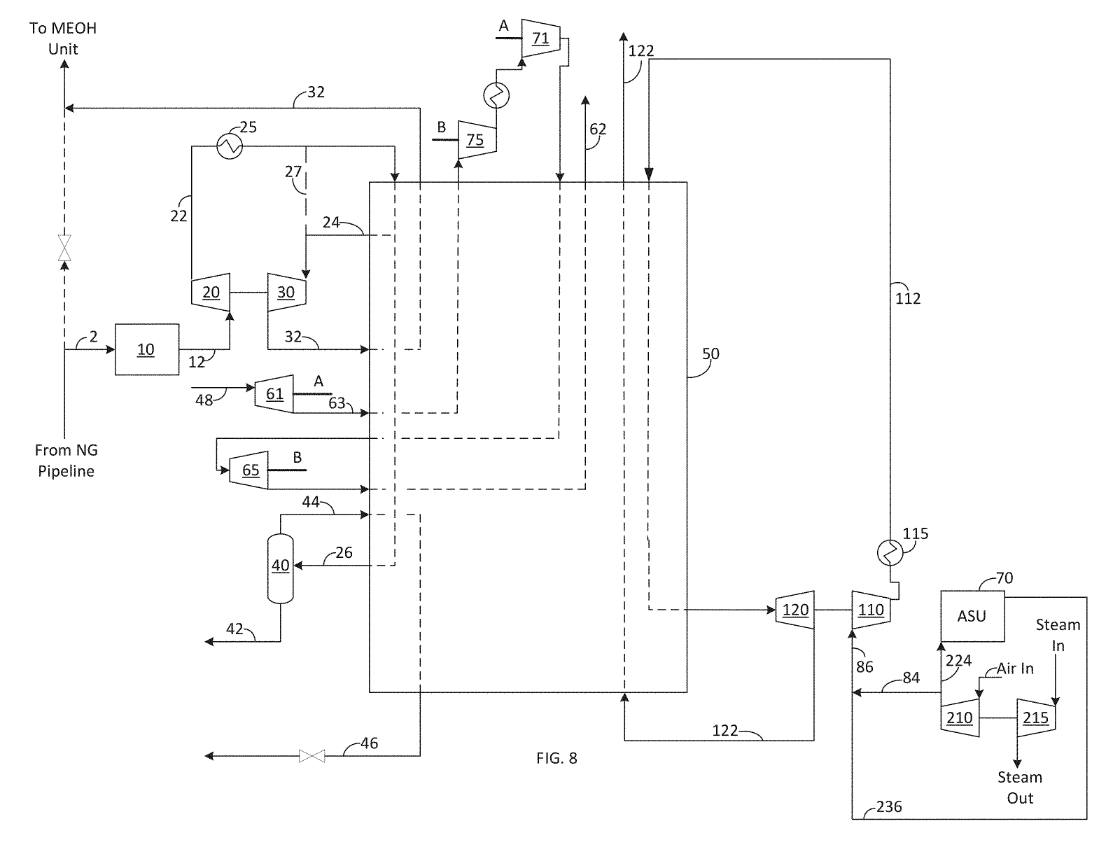

In the embodiment shown in FIG. 8, purge gas 48 can be expanded in first turbine 61. Following expansion, the expanded hydrogen rich purge gas 63 is warmed before being boosted in first booster 75 and second booster 71, which can be driven by turbines 65 and 61, respectively. The compressed purge stream is then partially re-cooled in the main exchanger, expanded again in a second set of turbines 65 and re-warmed in the main exchanger, thereby providing additional refrigeration to the industrial gas. The expanded purge gas 62 is then sent to the methanol plant for use as fuel. This arrangement provides increased refrigeration production by utilizing the higher pressure ratios of the purge gas letdown while at least partially offset by additional cycle complexity and capital cost.

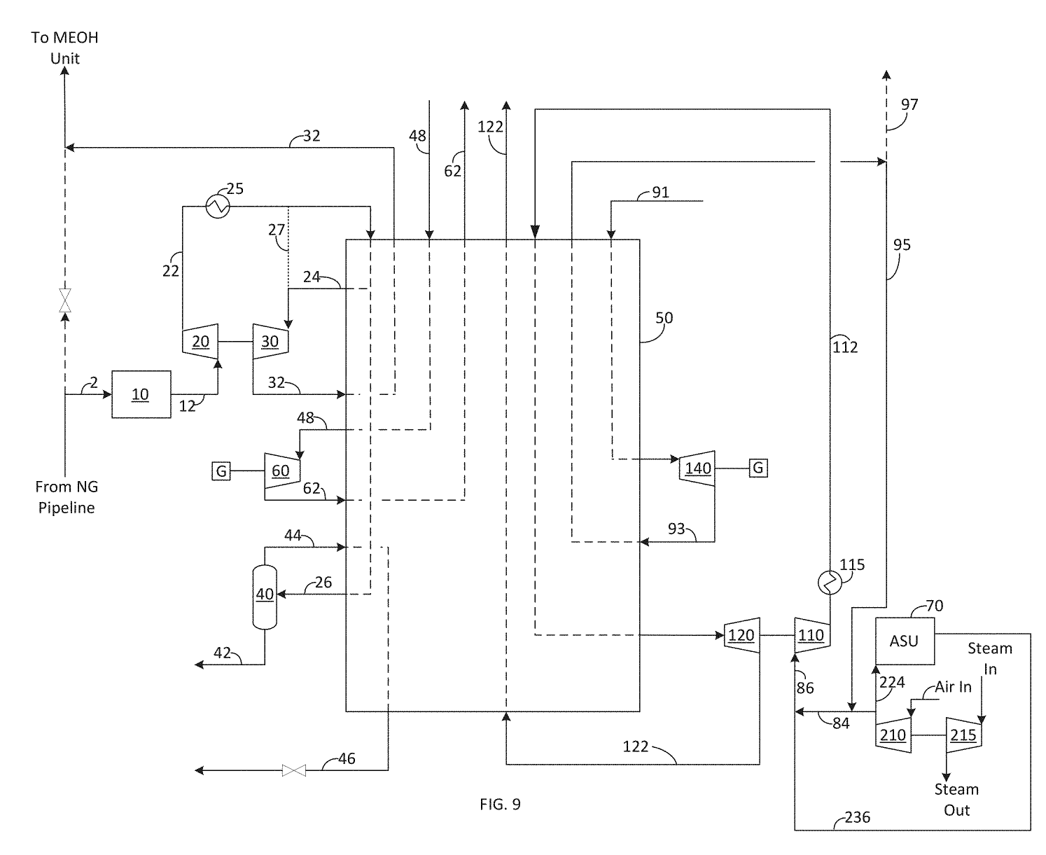

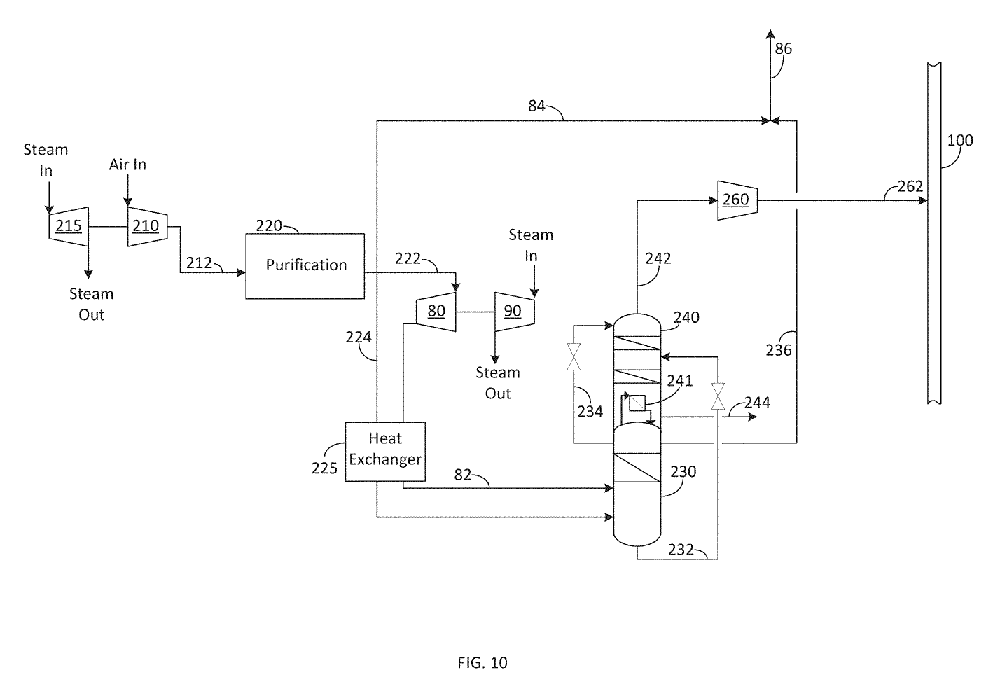

In the embodiment shown in FIG. 9, purge gas 48, which is a high pressure hydrogen rich stream (see 312 of FIG. 3) received from the methanol plant, can be partially cooled (e.g., the purge gas is removed from an intermediate section of the heat exchanger), expanded in second turbine 60 (or set of turbines arranged in series or parallel), which is linked to a generator G, to form expanded purge gas 62 before being warmed in the main exchanger, and sent back to the methanol plant as low pressure fuel (see 316 of FIG. 10). Expanded purge gas 62 provides a second portion of the refrigeration used to cool and eventually liquefy the natural gas.

Remaining with FIG. 9, the refrigeration can be supplemented by a supplemental high pressure nitrogen 91 sourced from a high pressure nitrogen source (e.g., a pipeline), which is preferably at a pressure of 15-100 bara. The supplemental high pressure nitrogen 91 is cooled in the main exchanger 50 and expanded in expander 140 to a pressure sufficient to mix with the ASU MAC air discharge pressure and the medium pressure nitrogen draw pressure (e.g., pressure of stream 236). In one embodiment, this high pressure turbine 140 drives a generator; however, those of ordinary skill in the art will recognized that it could also provide pre- or post-boost to the nitrogen stream.

Now returning to FIG. 8, in an optional embodiment, if second portion of the pressurized natural gas 26 (stream to be liquefied as product LNG) contains heavy hydrocarbons such as butane and heavier, it can be withdrawn at a second intermediate point of the heat exchanger and introduced to a liquid/gas separator or distillation column to remove heavy hydrocarbons 42, leaving a top gas 44 that is more concentrated in methane. Top gas 44 is reintroduced into the intermediate and/or cold end of heat exchanger 50, wherein it is further cooled and liquefied to form liquefied natural gas (LNG) 46.

Cold end refrigeration (i.e., temperatures colder than what can be achieved from the purge gas and natural gas expansion or colder than about −100° C. to −140° C.) can be provided by a boosted air stream 84, a nitrogen stream 236, and/or a nitrogen-air mixture 86. In the embodiment shown in FIG. 8, nitrogen-air mixture 86 is used. In the embodiment shown, nitrogen-air mixture 86 is at a medium pressure (e.g., approximately 4-7 bara) before being boosted by booster 110, cooled in aftercooler 115 to form high pressure air mixture, wherein it is partially cooled in heat exchanger 50, expanded in expander 120 to approximately the range of 1.1 to 2.0 bara to form expanded air mixture, and then warmed in heat exchanger 50. Expanded air mixture 122 provides a third portion of the refrigeration used to cool and eventually liquefy the natural gas. Following heat transfer, expanded air mixture 122 can be vented to the atmosphere, used as a dry gas to an evaporative cooling system, or recompressed.

In another embodiment, which is shown in FIG. 9, there may be a requirement for utility nitrogen at a pressure of 5 to 10 bara at the facility, which is typically supplied by a high pressure N₂ pipeline. In this embodiment, the discharge pressure of expander 140 may be adjusted slightly per the customer's demand pressure, such that a first portion 97 can be removed as product with the remainder 95 available for mixing with air 84 from MAC 210.

In another embodiment, heat exchanger 50 may be split into parallel trains such that there is little to no risk of cold refrigerant leaking and being in contact with the hydrogen rich purge gas, or natural gas streams. In this embodiment, the oxygen content in the cold refrigerant can be increased to that of the combustibility limits.

FIG. 10 provides a schematic representation of an air separation unit in accordance with an embodiment of the invention. Air is compressed in main air compressor (MAC) 210, which can be driven by a motor (not shown) or by steam turbine 215 if excess steam is available from a nearby source, such as the methanol unit, to produce compressed air 212. Compressed air 212 is then purified in purification unit 220 to remove components that will freeze at cryogenic temperatures (e.g., carbon dioxide and water). From there, compressed air 212 can be split into first portion 222, second portion 224, and third portion 84, wherein the second portion is cooled in ASU heat exchanger 225 and then introduced to the double distillation column for rectification therein. In certain embodiments, first portion 222 can be further compressed in booster air compressor (BAC) 80 before being cooled in the ASU heat exchanger 225 and then introduced into medium pressure column 230. Third portion of the compressed air stream 84 is sent to the liquefier as described in FIG. 8 or FIG. 9, either alone or combined with nitrogen stream 236 from medium pressure nitrogen stream 236 (e.g., the combination of air 84 and nitrogen 236 forms nitrogen-air mixture 86).

The double distillation column shown is a typical double distillation column in an air separation unit comprising lower pressure column 240, shared condenser/reboiler 241, and higher pressure column 230 (sometimes also referred to herein as medium pressure column). Bottoms liquid 232 rich in oxygen is expanded across a valve before being introduced into lower pressure column 240 for further separation. Nitrogen stream 234 is also introduced into lower pressure column 240 as reflux. Liquid oxygen stream 244 is produced at a bottom section of lower pressure column 240 as product or vaporized in ASU heat exchanger 225 for gaseous oxygen production (not shown). Low pressure nitrogen stream 242 is produced at the top of low pressure column 240, and medium pressure nitrogen stream 236 is produced at a top portion of higher pressure column 230.

In one embodiment, low pressure nitrogen stream 242 can be further compressed by compressor 260 to form high pressure nitrogen 262, which can then be introduced to nitrogen pipeline 100.

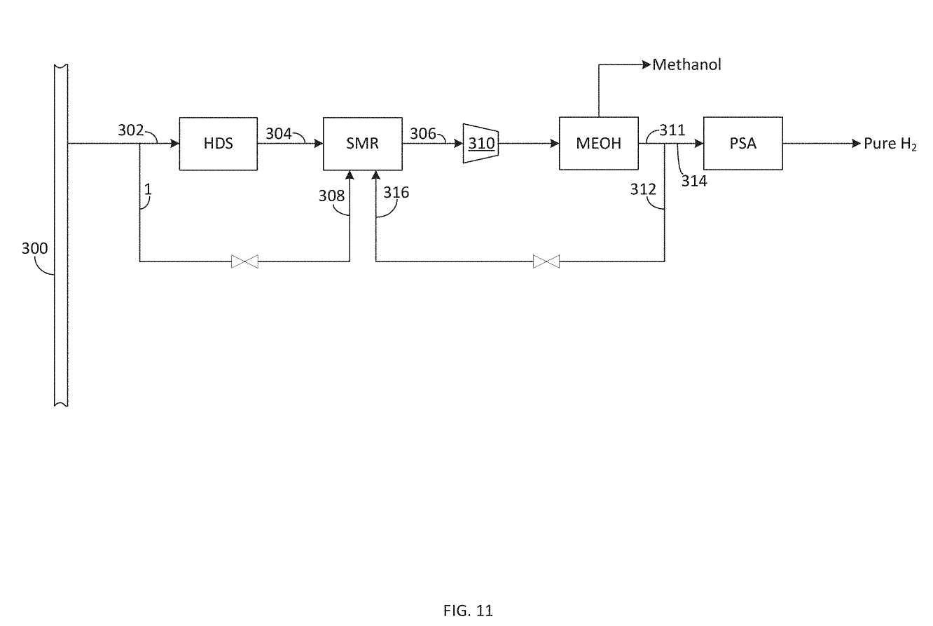

FIG. 11 provides a schematic overview of a methanol plant 301. Natural gas is withdrawn from natural gas pipeline 300, with a first portion of the natural gas 302 being sent to a hydro-desulfurization (HDS) unit to remove sulfur to form a desulfurized natural gas 304. This stream is then sent to a steam methane reformer (SMR) under conditions effective for producing syngas 306, which is then pressurized in compressor 310 before being sent to the methanol production facility (MEOH) under conditions effective for producing methanol and a purge gas 311. A first portion of the purge gas 314 is then sent to a pressure swing adsorber (PSA) in order to recover purified hydrogen. In a typical methanol plant, second portion of the purge gas 312, which is at an increased pressure of only nominally less than that of the discharge pressure of compressor 310, is typically expanded across a valve to very low pressure (e.g., about atmospheric pressure) and then sent to the SMR for use as purge gas fuel 316. Similarly, it is typical to supplement this fuel by use of a second portion of the natural gas 1 for use as fuel to the SMR after expansion in a valve via line 308.

FIG. 12 provides a schematic overview of an integrated methanol plant, liquefier and ASU in accordance with an embodiment of the present invention. In embodiments of the present invention, instead of wasting the expansion energy of natural gas 1 and second portion of the purge gas 312 by expansion across a valve, natural gas 2 and purge gas 48 are sent to the liquefier, as described in FIG. 8 or FIG. 9, in order to provide a portion of the refrigeration used to cool and liquefy the natural gas.

Integration of the methanol plant, liquefier, and ASU provides significant energy savings compared to a stand-alone natural gas liquefier. In one embodiment, all of the refrigeration used for liquefaction of the gas stream is provided by the cooling energy provided from the expansion of the natural gas, purge gas and air gas from the ASU (or nitrogen pipeline), thereby providing liquefaction of the natural gas and/or nitrogen gas with minimal or no additional compression costs. Alternatively, for increased liquefaction, this liquefaction energy can be supplemented by one or more additional liquefaction energy sources such as a cycle compressor driven by electric, gas turbine, or steam turbine drive.

In the embodiment shown in FIG. 8, 274 mtd of LNG can be produced using between 92 and 163 kW/mt depending on if free steam is available to drive the main air compressor. In the embodiment of FIG. 2, approximately 428 mtd LNG can be produced for about 146 kW/mt if free steam is available to drive the air compressor and 223 kW/mt if free steam is not available. In comparison, a stand-alone LNG plant would produce that amount of LNG for about 660 kW/mt. Clearly, even without free steam, embodiments of the invention provide a significant operational savings.

As used herein, “purge gas stream” is process gas to be withdrawn from the pressurized synthesis process to remove impurities and inerts from the catalytic process. The purge gas from methanol plants typically contains between 50-80% hydrogen.

In their most simple forms, embodiments of the present invention include integration of a gas processing unit with a hydrogen liquefaction unit, wherein the gas processing unit provides a portion of the refrigeration using available letdown energy that would otherwise be wasted in order to liquefy the hydrogen.

In certain embodiments, the gas processing unit may contain a methanol (MeOH) plant and in some cases a methanol to propylene plant. In another embodiment, pressurized air and/or nitrogen from an air separation unit may also be used to provide letdown energy for the hydrogen liquefier. In certain embodiments, it is proposed to integrate the underutilized letdown energy of the gas processing unit into the liquefaction unit to produce a liquid at a reduced operating cost.

In certain embodiments, gas processing units contain one or more high pressure supply gas streams that provide gas to a medium pressure consumer. Some systems also have underutilized compression capacity, which can be utilized such that the gas can be letdown to atmospheric pressure and vented or recycled. The energy extracted from the pressure letdown streams may be used to provide refrigeration for a counter current heat exchange with the hydrogen gas to be liquefied.

In typical operations of many gas processing units, it is common to letdown higher pressure gas streams without recovery of any of the resulting refrigeration produced during expansion of the gases.

For example, a methanol plant requires large quantities of natural gas feed from a high pressure transmission network. A portion of this natural gas feed is reduced in pressure through a control valve to low pressure and burned as fuel in one or more of the following: the steam methane reformer (SMR), fired heater, gas turbine, auxiliary boiler, steam boiler, and auxiliary burners.

The remaining portion (and majority) of the natural gas feed is processed in a desulfurization unit, and reacted in the SMR and/or the autothermal reformer (ATR) to produce a syngas. In a methanol plant, the syngas (which contains carbon dioxide, carbon monoxide, methane, and hydrogen and has a combined molecular weight of about 11) is further compressed to approximately 50-150 bara and reacted to produce methanol and a pressurized byproduct stream that is hydrogen rich. This byproduct stream can be split into two fractions, with the first fraction going to a pressure swing adsorber (PSA) to produce a purified hydrogen product, and the remaining second fraction, referred to as a purge gas, is typically reduced in pressure with a control valve to approximately 0.3-7 bara and used as fuel within the methanol plant.

This compression energy is required for the production of methanol, but can be utilized in certain embodiments of the present invention without any additional energy input for the very cold refrigeration level of a hydrogen liquefier by utilizing the letdown energy of the purge gas. Unlike the prior art where the refrigeration compression energy must be specifically and solely allocated to the liquefaction of hydrogen, embodiments of the present invention can reduce or even eliminate the need to compress the hydrogen stream to be liquefied by using the pressurized hydrogen coming from the methanol plant. In addition, the molecular weight of the compressed stream of certain embodiments of the present invention (MW=11) is higher than both Quack's state of the art liquefier of 8 and the classical liquefiers of 2 for hydrogen or 4 for helium.

In another embodiment, the gas processing unit can include a methanol to propylene (MMTP) facility. These facilities also require large quantities of gaseous nitrogen as a utility gas at a pressure of approximately 8 bara, which is supplied by pressure letdown from a nearby high pressure (˜37 bara) nitrogen pipeline.

Therefore, in certain embodiments, there can be at least three streams having underutilized pressure letdown energy: high pressure nitrogen letdown for utility gas, high pressure natural gas letdown for use as fuel, and hydrogen rich purge as letdown as fuel, which typically do not utilize the high pressure energy available of the pressure control valves. Additionally, the methanol process also produces a high pressure hydrogen product stream, which can be designed for increased flow and used for refrigeration expansion purposes.

In certain embodiments, the potential high pressure energy of these streams may be utilized by expansion of the streams in conjunction with expansion of a pressurized nitrogen gas stream from a high pressure nitrogen pipeline to low pressure or vent.

An additional source of refrigeration can be provided by expansion of a pressurized gas stream originating from an ASU such as air from the discharge of the booster air compressor (BAC), pressurized nitrogen from a pipeline or a nitrogen compressor, and combinations thereof. For purposes herein, nitrogen sourced from a pipeline is considered to be a pressurized gas stream originating from an ASU.

In normal operation of an ASU, it is typical for the BAC to operate below its maximum design condition. This is because the maximum design conditions are often based on worst case conditions (e.g., maximum liquid products, maximum high pressure gaseous oxygen, summer conditions, etc . . . ), which may be occasionally required but are rarely an actual operating point. Additionally, the design capacities of the major equipment such as MAC and BAC can be maximized to the limit of a step change in capital cost, for example based on the limit of a compressor frame size. Therefore, in a typical air separation unit, there is often excess capacity available from the BAC, the MAC, and pretreatment such that high pressure air can be withdrawn from the ASU at approximately 40-70 bara with little or zero additional capital cost and only a small incremental increase in operational costs. With integration of the methanol plant, additional savings can be achieved by driving the MAC and BAC using steam turbines using available steam from the methanol plant.

In another embodiment, a portion of the high pressure air that is not sent to the ASU cold box can be mixed with available high pressure nitrogen (HPN₂) from a nitrogen pipeline at approximately 30-70 bara. This can result in a low-cost, lean synthetic high pressure air (or impure N₂) stream at approximately 30-70 bara to be available for expansion refrigeration in the liquefier. In one embodiment, the air injection may be limited by the combustibility limit of O₂ in methane (approx 12%) or O₂ in H₂ (approx 6%) or by design margin to these limits if there is a potential leak.

Therefore, certain embodiments of the invention provide for an improved process for liquefaction of hydrogen that incorporates the available wasted energy of these aforementioned processes in an efficient manner. In another embodiment, the process can also include liquefaction of natural gas and/or liquefaction of nitrogen.

FIG. 11 provides a schematic overview of a typical methanol plant 301. Natural gas is withdrawn from natural gas pipeline 300, with a first portion of the natural gas 302 being sent to a hydro-desulfurization unit to remove sulfur to form a desulfurized natural gas 304. This stream is then sent to a steam methane reformer (SMR) in order to produce syngas 306, which is then pressurized to approximately 70 bara in compressor 310 before being sent to the methanol production facility under conditions effective for producing methanol and a purge gas 311. A first portion of the purge gas 314 is then sent to a pressure swing adsorber (PSA) in order to recover purified hydrogen. In a typical methanol plant, second portion of the purge gas 312, which is at an increased pressure (˜70 bara) of only nominally less than that of the discharge pressure of compressor 310, is typically expanded across a valve to very low pressure (e.g., about atmospheric pressure) and then sent to the SMR for use as purge gas fuel 316. Similarly, it is typical to supplement this fuel by use of a second portion of the natural gas 1 for use as fuel to the SMR after expansion in a valve via line 308.

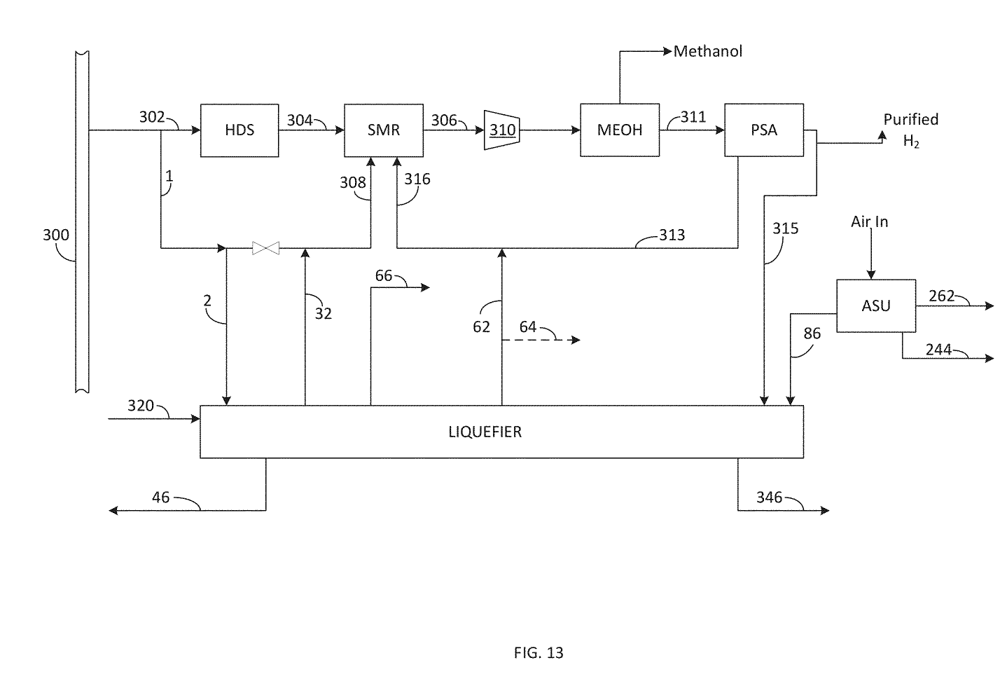

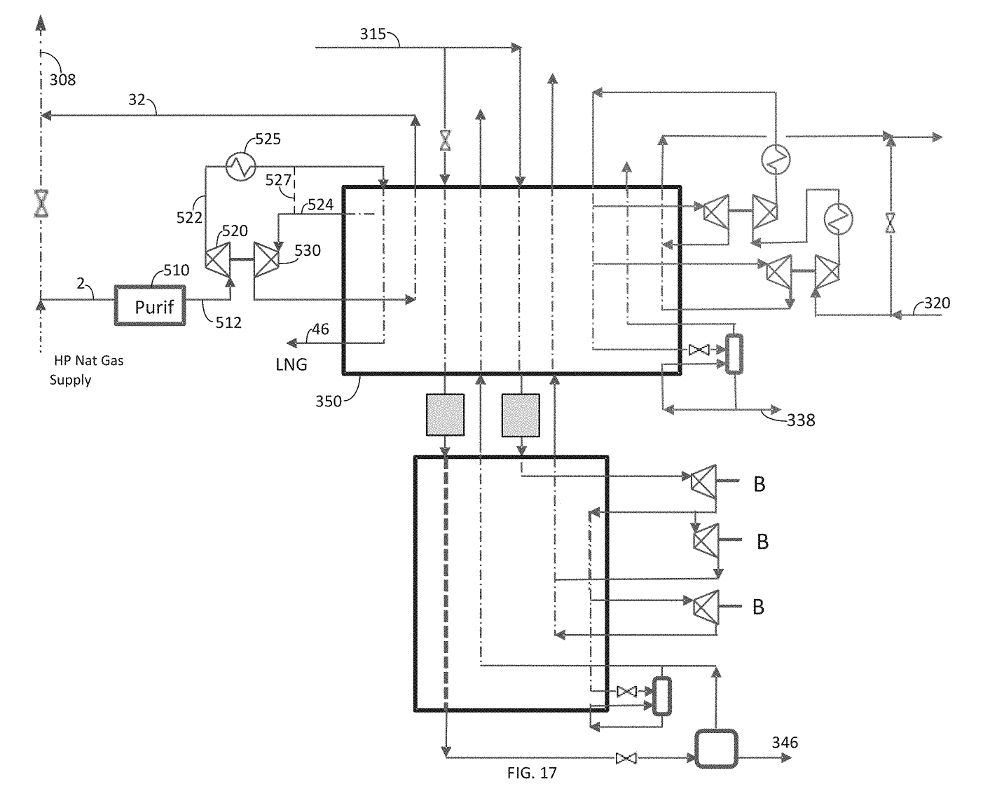

FIG. 13 provides a schematic overview of an integrated methanol plant, liquefier and ASU in accordance with an embodiment of the present invention. In one optional embodiment of the present invention, instead of wasting the expansion energy of natural gas 1 by expansion across a valve, natural gas 2 can be sent to the liquefier, as described in FIG. 17, in order to provide a portion of the refrigeration used to cool and liquefy the natural gas.

Additionally, instead of expanding and sending second portion of purge gas 312 to the SMR as fuel 316, all of purge gas 311 is sent to the PSA in order to produce additional high pressure purified hydrogen. Therefore, in certain embodiments of the present invention, the PSA used to purify the purge gas 311 is preferably larger than normal in order to accommodate the increased volumetric flow of purge gas 311 to the PSA. In another embodiment, in order to make up for the missing sending second portion of purge gas 312 used as a supplemental fuel source to the burners of the SMR, the impurities 313, which are adsorbed during the adsorption phase of the PSA and desorbed during the regeneration phase of the PSA, can be sent from the PSA to the SMR. In operation, these desorbed impurities from the PSA are at low pressure.

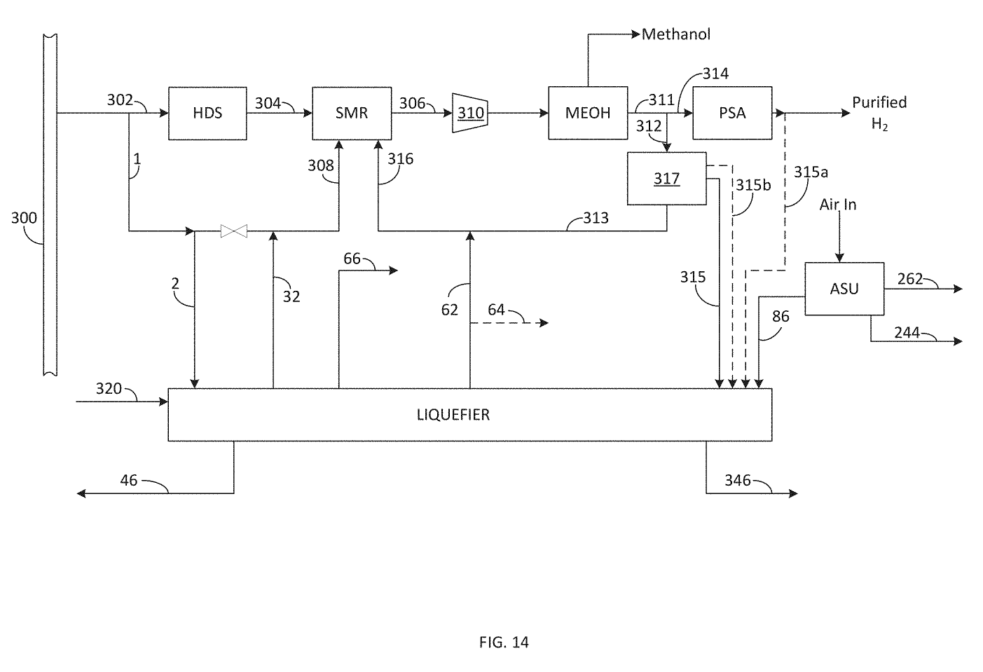

As noted, in certain embodiments of the present invention, the volumetric flow rate of the purified hydrogen can be increased as compared to normal operation. This allows for sending a first portion of the purified hydrogen 315 to the liquefier, which will be discussed in more detail in FIGS. 14-16. As this purified hydrogen stream is already at an elevated pressure (e.g., over 60 bara), certain embodiments of the invention do not require use of a hydrogen feed compressor or refrigeration cycle compressor for the very low temperature level of the cycle.

The other source of refrigeration energy can be provided by letting down high pressure nitrogen 320 coming from a nitrogen pipeline. Details of the refrigeration cycle are shown in FIGS. 14-16. The hydrogen liquefier is operated under conditions effective for producing liquid hydrogen product 346 and low pressure hydrogen 62, 64. In certain embodiments, liquefier can also produce LNG 46, and medium pressure nitrogen 66, which can be used for as a utility gas in a nearby facility, for example the methanol plant 301.

While FIG. 13 does not show second portion of the purge gas 312, certain embodiments of the invention can include using second portion of the purge gas 312 as a potential source for letdown refrigeration energy. Second portion of the purge gas, which is a high pressure hydrogen rich stream received from the methanol plant, can be partially cooled (e.g., the purge gas is removed from an intermediate section of the heat exchanger), expanded in a turbine (or set of turbines arranged in series or parallel), which can be linked to a generator or booster or other system for dissipation to atmosphere, to form an expanded purge gas before being warmed in the main exchanger of the liquefier, and sent back to the methanol plant as low pressure fuel (see 316 of FIG. 13). The expanded purge gas can therefore provide an additional source of the refrigeration used to cool and eventually liquefy the hydrogen.

In another embodiment not shown, after the expanded hydrogen rich purge gas is re-warmed it may be boosted (in a booster which is driven by the expander), re-cooled in the main exchanger, expanded again in a second set of turbines and re-warmed in the main exchanger. This arrangement provides increased refrigeration production by utilizing the higher pressure ratios of the purge gas letdown while at least partially offset by additional cycle complexity and capital cost.

Integration of the methanol plant, liquefier, and optional ASU provides significant energy savings compared to a stand-alone hydrogen liquefier. In one embodiment, all of the refrigeration used for liquefaction of the hydrogen gas stream is provided by the cooling energy provided from the expansion of nitrogen from a nitrogen pipeline and expansion of a portion of the purified hydrogen product stream from the PSA. In additional embodiments, additional sources of refrigeration can include expansion energy provided by pressurized natural gas from a natural gas pipeline and air gas from the ASU. Alternatively, for increased liquefaction, this liquefaction energy can be supplemented by one or more additional liquefaction energy sources such as a cycle compressor driven by electric, gas turbine, or steam turbine drive.

FIG. 14 provides an alternate embodiment to the integrated methanol plant, liquefier and ASU shown in FIG. 13. In FIG. 13, all of the purge gas 311 from the methanol unit MEOH was sent to the PSA for purification. However, in the embodiment of FIG. 14, like the embodiment shown in FIG. 11, a portion of the purge gas 312 is withdrawn. However, instead of sending it to the SMR for use as fuel, the stream is sent to a second PSA 317 for treatment in order to produce high pressure hydrogen rich gas 315. Low pressure impurities 313 are again sent to the SMR after combining with low pressure hydrogen 62 for use as fuel. The embodiment shown in FIG. 14 is particularly advantageous for situations in which there is already an existing methanol facility, and the hydrogen liquefier is built as an add-on. Since second PSA 317 is added, the original PSA does not need to be replaced with a larger unit. This allows for an easier and more economical way of upgrading an existing site with minimal downtime.

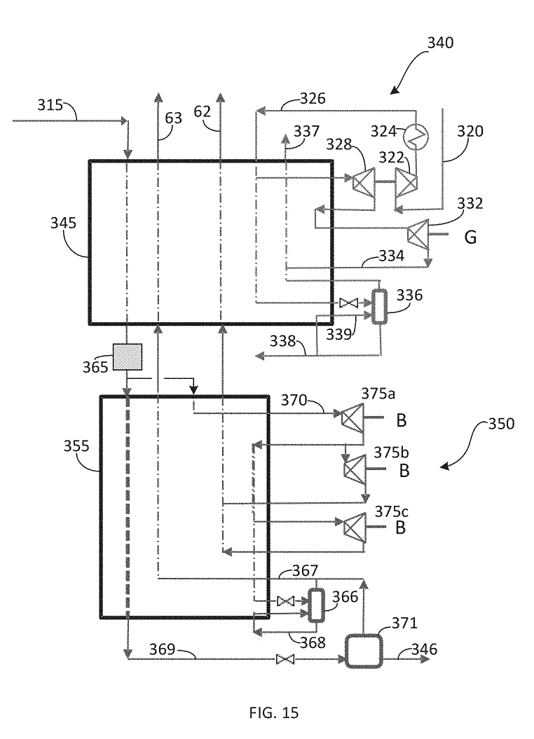

FIG. 15 provides a schematic representation of an embodiment utilizing high pressure energy of (1) high pressure nitrogen gas 320 from a pipeline that is being letdown to low pressure vent and (2) high pressure hydrogen rich gas 315 letdown for use as fuel or low pressure product.

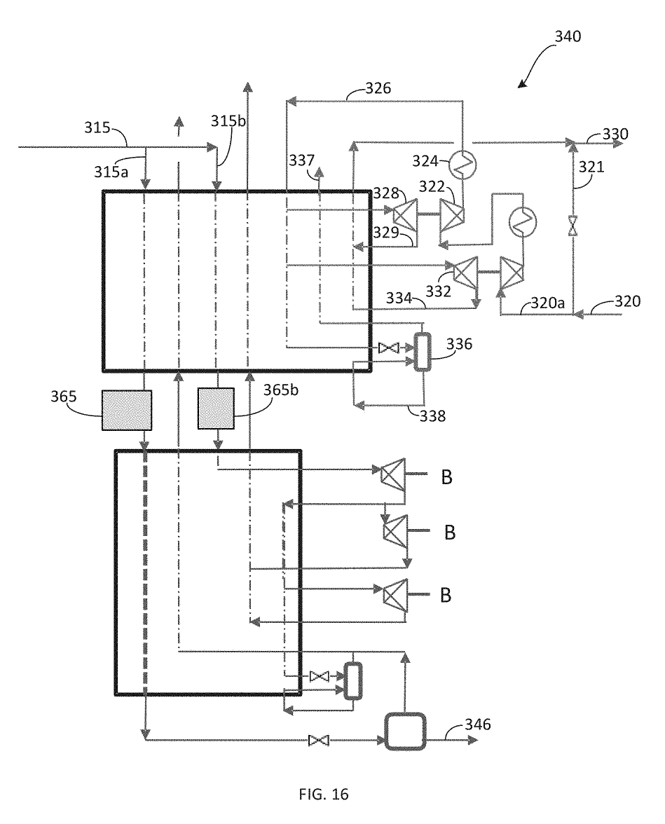

Nitrogen refrigeration cycle 340 provides the warm temperature cooling, while hydrogen expansion 350 provides the cold temperature cooling. In nitrogen refrigeration cycle 340, high pressure nitrogen 320, which is preferably sourced from a nitrogen pipeline operating at more than 30 bara, can be further compressed in nitrogen booster 322 and cooled in aftercooler 324 to form boosted nitrogen 326. A first portion of this boosted nitrogen can then be slightly cooled in first heat exchanger 345 before being expanded in nitrogen turbine 328, cooled again in first heat exchanger 345, expanded again in second nitrogen turbine 332 to about atmospheric pressure to form fully expanded nitrogen 334, which is then re-warmed and vented to the atmosphere. Nitrogen turbine 328 provides power used by nitrogen booster 322. In the embodiment shown, second nitrogen turbine 332 is connected with a generator G thereby producing electricity, which can be sold back to the grid. Those of ordinary skill in the art will also recognize that second nitrogen turbine 332 can be connected with a second nitrogen booster (see FIG. 16) depending on the operating conditions (e.g., flow rates, pressures, expansion ratios, thermodynamics, etc.) of the system.

In the embodiment shown, a second portion of the boosted nitrogen is at least partially condensed within the first heat exchanger 345 and withdrawn at a colder location than the first portion, before being pressure reduced across a valve to atmospheric pressure and introduced to liquid/gas separator 336. The gaseous portion 337 is re-warmed in first heat exchanger 345 and eventually vented to the atmosphere. Liquid nitrogen (LIN) 338, is withdrawn from the bottom of liquid/gas separator 336, with a portion 339 being warmed and partially vaporized before being then recycled back to the liquid/gas separator 336. Portion 339 acts as a thermosiphon.

First portion of the purified hydrogen 315 can be expanded in valve (not shown) before being cooled in first heat exchanger 345, preferably to a temperature sufficient to condense out impurities without freezing said impurities, such as argon, etc. These impurities are then removed in hydrogen purification unit 365 so that they do not freeze during cold temperature cooling within second heat exchanger 355. In the embodiment shown, the purified hydrogen is split into two portions, with one portion 369 being liquefied in second heat exchanger 355, while the other portion is used to provide the cold temperature cooling via hydrogen expansion 350. The liquefied portion 369 can then be expanded in a valve and introduced to separator 371. Liquid hydrogen 346 is withdrawn as product.

In the embodiment shown, the other portion of the purified hydrogen 370 is slightly cooled in second heat exchanger 355 before undergoing a series of expansion steps in hydrogen turbines 375a, 375b, 375c to produce a cold medium pressure hydrogen stream that is then re-warmed in second heat exchanger 355 and first heat exchanger 345 to form warm medium pressure hydrogen 62, which can be sent back to the SMR for use as fuel, or used for some other purpose 64.

As with the nitrogen refrigeration cycle 340, a second fraction of the hydrogen is at least partially condensed within the second heat exchanger 355 and withdrawn at a colder location than the rest of the hydrogen 370, before being pressure reduced across a valve to about atmospheric pressure and introduced to liquid/gas separator 366. The gaseous portion 367 is re-warmed in second heat exchanger 355 and first heat exchanger 345 to form low pressure hydrogen. Liquid hydrogen 368, is withdrawn from the bottom of liquid/gas separator 366, and then recycled back to the liquid/gas separator 366, again acting as a thermosiphon.

In the embodiment shown, by providing approximately 57 mtd of 65 bara hydrogen (stream 315) and about 390 mtd nitrogen at 36 bara (stream 320), the method can provide approximately 11 mtd liquid hydrogen (stream 346), 42 mtd medium pressure hydrogen (stream 62), 4 mtd low pressure hydrogen (stream 63), while also producing around 160 kW of energy from second nitrogen turbine 332.

FIG. 16 provides a schematic representation of a second embodiment utilizing high pressure energy of (1) high pressure nitrogen gas 320a from a pipeline that is being letdown to low pressure vent and (2) high pressure hydrogen rich gas 315 letdown for use as fuel or low pressure product. In this embodiment, instead of expanding all of the nitrogen to atmospheric pressure using first and second expanders 328, 332 connected in series, a portion of the nitrogen 329, 334 is expanded to a medium pressure in the first and second expanders 328, 332 connected in parallel. This is particularly advantageous if there is a nearby user of nitrogen utility gas, since that user likely would have just flashed the high pressure nitrogen gas from the pipeline to medium pressure without capturing any of the refrigeration energy potential of the gas stream. Depending on the flow of medium pressure nitrogen 330 needed, if portions of nitrogen 329, 334 are not enough, additional nitrogen can be provided via by-pass line 321.

Additionally, this embodiment shows an example of splitting the initial high pressure hydrogen 315 into two streams 315a, 315b upstream of the first heat exchanger 345. In doing this, an additional purification unit 365b is also employed. In the embodiment shown, hydrogen stream 315a gets liquefied and hydrogen stream 315b provides the cold temperature cooling.

In the embodiment shown, by providing approximately 57 mtd of 65 bara hydrogen (stream 315) and about 626 mtd nitrogen at 37.5 bara (stream 320a), the method can provide approximately 11 mtd liquid hydrogen (stream 346), 42 mtd medium pressure hydrogen (stream 62), 4 mtd low pressure hydrogen (stream 63), and 543 mtd of medium pressure nitrogen (streams 329 and 334) at 8.5 bara.

In the embodiment shown in FIG. 15, the process uses available capacity of any upstream underutilized nitrogen compression equipment upstream the nitrogen pipeline. This nitrogen pipeline compression equipment may be underutilized since typical design requires capacity for worst operating conditions (e.g., summer, end of catalyst life, maximum consumer operating conditions), which occurs infrequently. In one embodiment, the hydrogen liquefier can be configured to operate periodically (i.e., not continuous), such that in certain embodiments, the hydrogen liquefier is proposed to only operate at times when the extra nitrogen compression capacity is available. In certain embodiments, the result is the typically used nitrogen recycle compressor can be removed yielding reduced opex and significantly reduced capex for the liquefier. This is in addition to the capex plus opex savings due to integration with the hydrogen letdown.

FIG. 16 differs from FIG. 15 in that the embodiment of FIG. 5 expands at least a portion of the high pressure nitrogen gas to a medium pressure for use as a utility gas. Additionally, the embodiment shown in FIG. 16 does not require underutilized nitrogen compression equipment capacity, but rather incorporates a consumer for medium pressure nitrogen. This is particularly useful if a nearby industrial site (e.g., MeOH plant) requires large quantities of medium pressure nitrogen as a utility gas. In this case, the nitrogen that would have been letdown to a medium pressure consumer by wasting the energy through a valve is now letdown with expansion turbines to recover the energy yielding near “zero energy” opex and significantly reduced capex for the liquefier.

At least a portion of these high pressure nitrogen and hydrogen streams are diverted to an exchanger where they are cooled down, then expanded in their respective turbines to extract energy and produce colder process streams, which are then re-warmed in the exchanger to cool the turbine inlet streams as well as the fluid to be liquefied (e.g., hydrogen). Other arrangements of turbine booster are possible.

The cold adsorbers 365, 365b are used to remove nitrogen and argon from the hydrogen streams 115a, 115b entering the very cold section 355 of the process where these components would freeze and damage equipment. A single large cold adsorber system can be used by combining the hydrogen stream being expanded with the hydrogen stream to be liquefied as product, cooling in the warm section, purifying and then splitting the stream to be liquefied from the stream to be expanded (FIG. 15). Alternatively, separate cold adsorber units can be used for the stream to be liquefied and the stream to be expanded (FIGS. 15 and 16). Alternatively, the nitrogen and argon can be removed in a purification system on the combined warm end such that the cold adsorbers can be removed. The location of this adsorption step is independent and not impacted by the nitrogen refrigeration cycle differences between FIGS. 14 and 15.

While the size of the PSA for certain embodiments of the present invention, as compared to a PSA of the prior art, can be significantly increased in order to generate the hydrogen for expansion in the liquefier, this cost is offset by the removal of the hydrogen cycle compressor and energy savings.

In one embodiment, only the hydrogen letdown is used for providing the secondary cooling (e.g., temperatures below −190° C.), such that the hydrogen recycle compression is removed. In one embodiment, the warmed medium pressure hydrogen leaving the liquefaction unit can be either used as medium pressure hydrogen product or sent back to the industrial site (MeOH plant), wherein it is mixed with the PSA off-gas and consumed as fuel. This refrigeration provided for the cold end of the hydrogen liquefier is independent from the various options for the nitrogen cycle of the warm (e.g., >−190° C.) section. The result is at least partially reduced opex and reduced capex.

FIG. 17 presents a schematic diagram of an embodiment in which the letdown energy of a natural gas stream is used to produce both LNG and additional liquefied nitrogen (LIN). This embodiment can be particularly useful with an integrated methanol plant, since methanol plants require large flow rates of natural gas that is supplied from the high pressure natural gas pipeline (30 to 60 bara) and letdown to medium pressure (2-5 bara) and consumed as fuel gas. This high pressure natural gas can be expanded in a turbo-expander such that the cold is provided to the hydrogen liquefier to co-produce LNG and/or LIN.

Natural gas 2 is purified of carbon dioxide and water in purification unit 510 to form stream 512 before being compressed in compressor 520 to form pressurized natural gas 522. Pressurized natural gas 522 is then cooled by aftercooler 525 to remove heat of compression from compressor 520.

For the warm end refrigeration (i.e., temperatures warmer than about −100° C.), pressurized natural gas 522 is then cooled within heat exchanger 345, wherein a first portion of the pressurized natural gas 524 is withdrawn at a first intermediate point of the heat exchanger where it is expanded in turbine 530 to low pressure to form first expanded portion 532, before being warmed in heat exchanger 345 and subsequently sent to the methanol plant to be used as fuel (see lines 32 and 308 of FIG. 13). Alternatively, after exiting aftercooler 525, the pressurized natural gas may be sent directly to the inlet of turbine 530 via line 527 rather than cooling the gas in exchanger 50 for the purpose of limiting the temperature at the discharge of the turbine First expanded portion 532 provides a portion of the refrigeration used to cool and eventually liquefy the natural gas, as well as cooling the hydrogen. The turbine 530 can drive a generator or booster to pre-boost the total natural gas feed as shown, only the natural gas to be liquefied, only the natural gas to be expanded, or to post-boost the natural gas which was expanded.

In an optional embodiment, if the natural gas stream to be liquefied as product LNG contains heavy hydrocarbons such as butane and heavier, it can be withdrawn at a second intermediate point of the heat exchanger and introduced to a liquid/gas separator or distillation column (not shown) to remove heavy hydrocarbons, leaving a top gas that is depleted of heavy hydrocarbons. Top gas is reintroduced into the intermediate and/or cold end of heat exchanger, wherein it is further cooled and liquefied to form liquefied natural gas (LNG) 46.

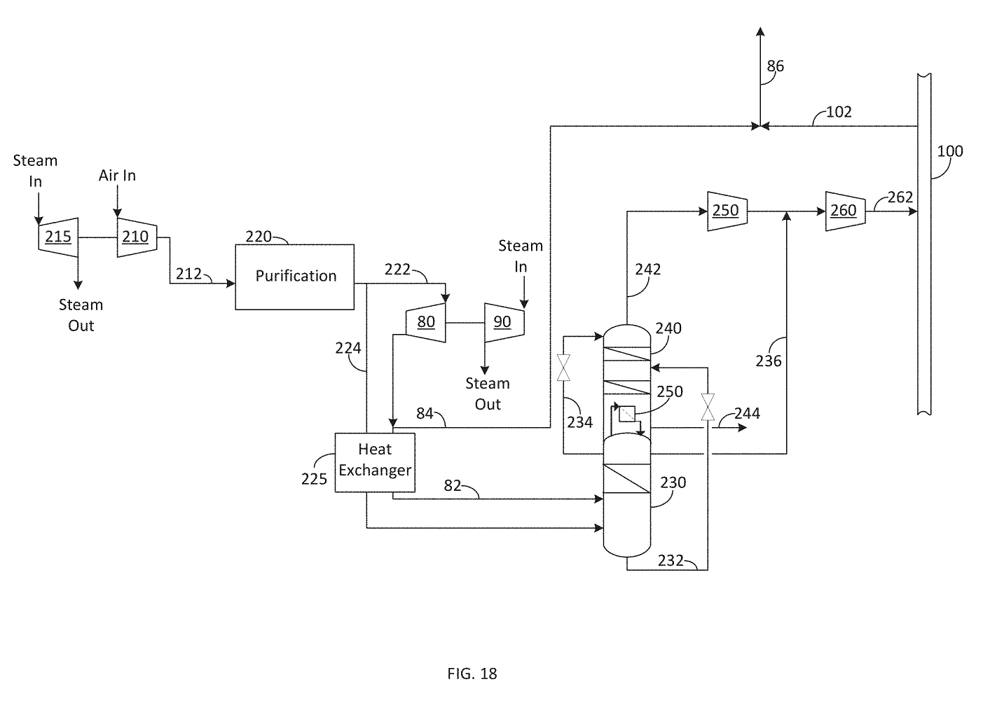

FIG. 18 provides a schematic representation of an optional air separation unit in accordance with an embodiment of the invention. Air is compressed in main air compressor (MAC) 210, which can be driven by a motor (not shown) or by steam turbine 215, particularly if excess steam is available, to produce compressed air 212. Compressed air 212 is then purified in purification unit 220 to remove components that will freeze at cryogenic temperatures (e.g., carbon dioxide and water). From there, compressed air 212 can be split into a first portion 222 and a second portion 224, is the second portion 224 being cooled in heat exchanger 225 and then introduced to the double distillation column. The first portion 222 is further compressed in booster air compressor (BAC) 80 with a first fraction 82 being cooled in the ASU heat exchanger 225 before being introduced into medium pressure column 230. The remaining boosted air stream 84 is sent to the liquefier as described in FIG. 13, either alone or combined with nitrogen stream 102 from nitrogen pipeline 100 (e.g., nitrogen-air mixture 86).

The double distillation column shown is a typical double distillation column in an air separation unit comprising a lower pressure column 240, a shared condenser/reboiler 250, and the higher pressure column 230. A bottoms liquid 232 rich in oxygen is expanded across a valve before being introduced into lower pressure column 240 for further separation. Nitrogen stream 234 is also introduced as reflux. Liquid oxygen stream 244 is produced at a bottom section of lower pressure column 240 as product or vaporized in ASU heat exchanger 225 for gaseous oxygen production. A low pressure nitrogen stream 242 is produced at the top of low pressure column 240, and medium pressure nitrogen stream 236 is produced at a top portion of higher pressure column 230.

In one embodiment, low pressure nitrogen stream 242 can be further compressed by compressor 250 and combined with medium pressure nitrogen stream 236, and then compressed by compressor 260 to form high pressure nitrogen 262, which can then be introduced to nitrogen pipeline 100. Alternatively, a portion of high pressure nitrogen 262 can be sent directly to the liquefier of FIG. 14 without first going to nitrogen pipeline 100.

Table I below presents a comparison of various compressors utilized in one method known in the prior art as compared to certain embodiments of the present invention. As is clearly shown, certain embodiments of the present invention do not require a hydrogen recycle compressor, a nitrogen recycle compressor, or a hydrogen process inlet compressor. This results in a substantial savings in equipment costs.

TABLE I
CAPEX Comparison of Standard Hydrogen Liquefier and
Embodiments of the Present Invention

| | | | Embodiments |
|---|---|---|---|
| | | | of the |
| Compressor | Compressor Size | Prior Art | Invention |
| H₂ Recycle | Large | Required | None |
| N₂ Recycle | Large | Required | None |
| H₂ Process Inlet | Small | Depends on H₂ | None |
| | | Source | |
| H₂ Cycle Feed | Small | Required | Site |
| | | | Dependent |
| N₂ Cycle Feed | Small | Required | Site |
| | | | Dependent |

In a typical stand alone hydrogen liquefier, the power requirements for producing liquid hydrogen are approximately 12 kWh/kg liquid hydrogen. The theoretical Quack Ne/He scheme was estimated to be 5-7 kWh/kg liquid hydrogen. However, embodiments of the present invention provide much better results. For example, the embodiment shown in FIG. 15 results in about 4.2 kWh/kg liquid hydrogen. The primary power used is for nitrogen compression from underutilized nitrogen pipeline capacity. The embodiment shown in FIG. 16 uses about 0.9 kWh/kg liquid hydrogen, with the power usage being attributed to low pressure nitrogen flash losses. The embodiment shown in FIG. 17 can liquefy hydrogen using “zero energy” (e.g., 0 kWh/kg produced liquid hydrogen) and about 0.2 kWh/kg LNG.

As used herein, warm temperature cooling is defined as cooling conducted at temperatures that are warmer than the freezing point of any impurities within the hydrogen stream to be liquefied that are removed within the hydrogen purification units. Similarly, cold temperature cooling is defined as cooling conducted at temperatures that are colder than the freezing point of any impurities within the hydrogen stream to be liquefied that are removed within the hydrogen purification units.

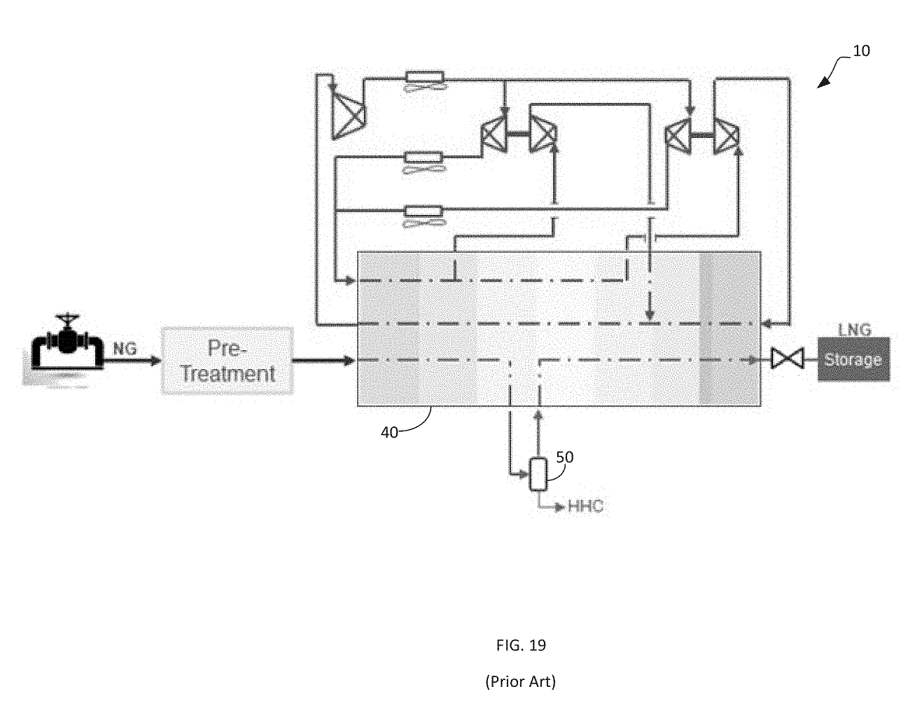

FIG. 19 is an example of a typical small LNG scheme that utilizes a nitrogen cycle (N₂ compressor and two turbine boosters) in a closed loop 10. Natural gas NG is cooled and condensed into LNG in passages separate and adjacent to the N₂ in the heat exchanger 40. In most small scale LNG plants, heavy hydrocarbons (HHC), which freeze at LNG temperatures, condense and are removed from the natural gas via a knock out drum 50. The specific power of such plant is highly dependent on the natural gas feed pressure and usually varies between 450 and 550 kWh/ton of LNG produced.

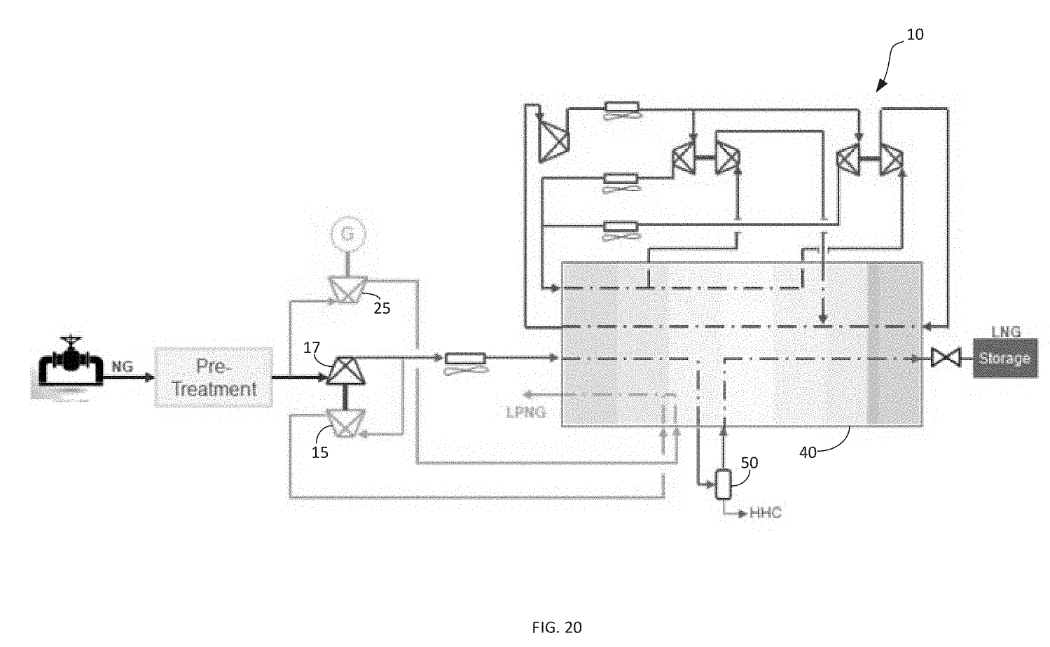

In one embodiment of the present invention, the system presented in FIG. 20 combines two natural gas turbines 15, 25 and a standard nitrogen liquefier 10. In the embodiment shown, the first natural gas turbine 15 is driving a first natural gas booster 17 that is used to set the pressure of the natural gas to a specified optimum value at the inlet of the cold box 20. This additional pressure boost to the natural gas stream is advantageous, since a high natural gas pressure (1) improves the heat exchange efficiency, (2) shrinks the size of the equipment, and (3) reduces overall costs. However, this pressure must also be maintained below the maximum allowable working pressure of the equipment design.

In certain embodiments, the natural gas operating pressure at cold box inlet can be limited by the critical pressure of the gas. This is because the HHC condensation requires the operating pressure to be less than the critical pressure for the separation of liquid and vapor to occur. Therefore, in certain embodiments, the limit to the natural gas critical pressure will set the maximum discharge pressure of the first natural gas booster 17 and thus the flow going to the first natural gas expander 15. In certain embodiments, the letdown flow rate available is higher than the flow rate required to reach the booster maximum suction pressure. When this occurs, second natural gas turbine 25 can be utilized.

In one embodiment, second natural gas turbine 25 can be configured to drive a generator, thereby producing additional electricity. This turbine 25 is completely independent from the first turbine 15, and uses the extra letdown flow available to produce electricity. In this way, the natural gas liquefaction stream can be maintained at its optimum pressure through a range of letdown flows and pressures.

Additionally, in certain embodiments, the nitrogen cycle flow may be adjusted such that the LNG production can be maintained independently from the letdown flow variation.

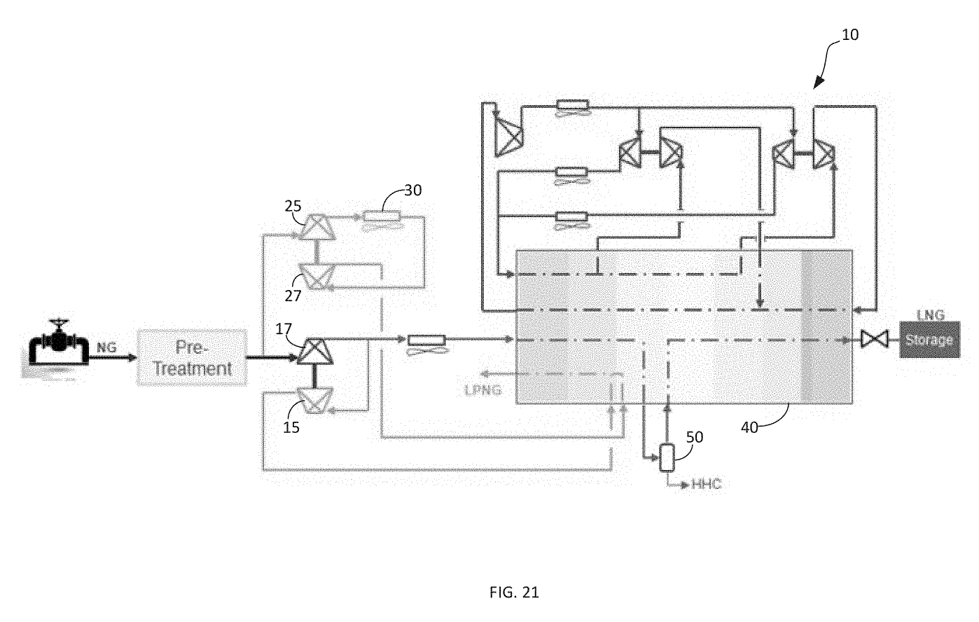

FIG. 21 presents an alternative embodiment in which a second booster 27 replaces the generator. The temperature of the booster aftercooler 30 may be adjusted such that no condensation appears at the discharge of second natural gas turbine 25. Alternatively (in an embodiment not shown), components which condense may be removed prior to expansion. Depending on the pressure ratio and flows, the natural gas can also be expanded prior to boosting in second booster 27. As this embodiment does not require a transformation of the mechanical energy into electrical energy, the embodiment presented in FIG. 21 is generally more efficient and cost competitive compared to the embodiment presented in FIG. 20.

In another embodiment not shown, the energy of the second natural gas turbine 25 may drive a booster which is compressing expanded LNG flash after the letdown valve to the LNG tank. The advantage of such system is to provide free cold energy at both the warm end (thanks to the natural gas expansion) and the cold end (thanks to LNG flash) of the liquefier with no natural gas losses, as it is recompressed to the low pressure network. Therefore, this embodiment is particularly efficient and is especially suited when using a bullet tank type storage, which has sufficient pressure to send the flash gas back at the warm end of the heat exchanger.

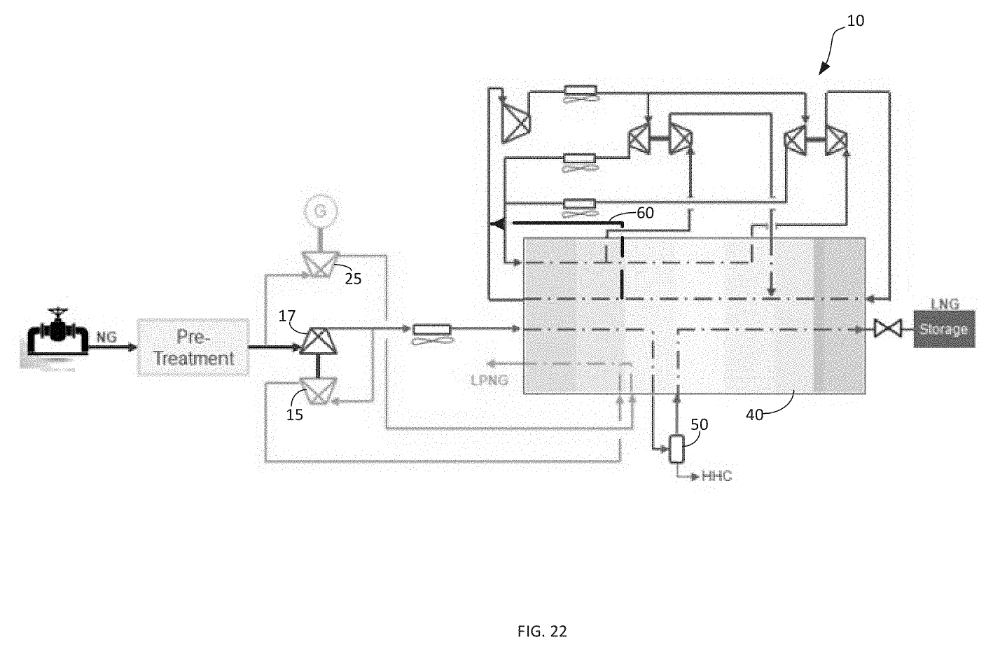

FIG. 22 presents another embodiment that is particularly useful for varying demands for the low pressure natural gas. As the low pressure natural gas flow and pressures vary, the relative amount of natural gas letdown energy varies compared to the N₂ cycle energy. As a result, the warm end of the heat exchanger may receive more cold than is needed. In addition to the loss of thermal efficiency, the warm end of the heat exchanger could get to a temperature that is colder than it was designed for, which could lead to structural issues, as well as premature freezing of components within other parts of the heat exchanger, particularly the heavy hydrocarbons. To alleviate this issue, certain embodiments of the invention can include a by-pass 60 of cold nitrogen at the warm end of the heat exchanger.

This by-pass 60 advantageously (1) enables an increase of the heat exchange efficiency in the heat exchanger and (2) reduces the power consumption of the nitrogen cycle compressor by cooling down its suction temperature.

In summary, embodiments of the invention provide for many improvements over conventional liquefaction techniques. For example, by increasing the feed pressure of the natural gas using a combination turbine booster (15, 17), the heat exchange efficiency is greatly improved, which allows for either an increase in LNG production capacity by keeping the same equipment size or reducing the size of the equipment, and therefore the overall footprint of the plant while maintaining current production capacity.

Additionally, expansion of natural gas enables to pre-cool the warm end of the heat exchanger reducing the specific power of the nitrogen cycle. The embodiments of the invention are very robust as they can adapt to a wide range of natural gas flow rates. This is due to the decoupling of the natural gas turbines 15, 25 with the ability to maintain the natural gas liquefaction pressure 17 with the first natural gas turbine 15.

In certain embodiments, the significant refrigeration brought to the warm end of the main exchanger by the natural gas letdown can allow for the removal of the warm nitrogen turbine and booster to reduce capital cost.

Moreover, the design of the main heat exchanger can optionally stay very similar to a standard nitrogen cycle plant, which means that no major changes in design are required.

In certain embodiments, all the expansion of the natural gas is carried out at ambient or warm temperatures, which results in limited risk of heavy hydrocarbon freezing at turbine outlets.

Additionally, for an incremental additional capital cost (natural gas turbine booster 15, 17 and turbine-generator 25), there can be a significant power savings as there is a corresponding reduction in nitrogen cycle size and power. This is shown in Table II below.

Table III below, provides data for an embodiment in which the flowrates and pressures of various streams could be adjusted based on the pressure of the natural gas coming from the pipeline in order to keep the LNG production at a constant pressure and flowrate.

TABLE III
Response of the system to a change of NG Feed pressure

| | | Case 01 | Case 04 | |
|---|---|---|---|---|
| | | (FIG. 2) | (FIG. 2) | Note |
| NG Feed Pressure | bar abs | 31 | 40 | +9 bar change in the feed gas |
| | | | | pressure |
| Liquefaction | bar abs | 48 | 48 | Kept Constant |
| Pressure | | | | |
| Letdown Pressure | bar abs | 6.5 | 6.5 | Kept Constant |
| Letdown Flow | MMSCFD | 29 | 29 | Constant Demand |
| LNG Production | MMSCFD | 21 | 21 | Constant Demand |
| Flow to NG | MMSCFD | 14 | 5 | Adjusted to keep the discharge |
| Turbine (15) | | | | pressure constant |
| Flow to NG | MMSCFD | 15 | 24 | Adjusted to deliver the rest of the |
| Turbine (25) | | | | letdown gas |
| N₂ Cycle Power | kW | 6,600 | 6,260 | −5% |
| (10) | | | | Reduced power mainly due to the |
| | | | | higher expansion power (higher |
| | | | | pressure ratio and flow) of NG |
| | | | | Turbine 25 |
| NG Turbine (15) | kW | 750 | 230 | −69% |
| Power | | | | Reduced Power due to the reduced |
| | | | | pressure ratio, and therefore |
| | | | | flowrate of Turbine 15 |
| NG Turbine (25) | kW | 550 | 1,008 | +83% |
| Power | | | | Higher power generation of |
| | | | | Turbine 25 |

The flows, pressure variations and impact on the machinery between Case 01 and Case 04 presented in Table III are merely one example, and are included herein for illustrative purposes.

As used herein, refrigeration that is produced “without the use of externally provided electricity” is to mean that any recycle compressors and boosters that may be used in a particular refrigeration source are not powered by an electrical motor. It is understood that various ancillary electrical loads such as lube oil pumps, cooling systems, etc. may still be required.

As used herein, refrigeration that is produced “with reduced amounts of externally provided electricity” is to mean that any recycle compressors and boosters that may be used in a particular refrigeration source use less electricity than if they were powered solely by an electrical motor.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

We claim:

1. A process for the production of a liquid by integration of a gas processing unit and a liquefaction unit, the process comprising the steps of:
a) providing a gas processing unit;
b) providing a liquefaction unit, wherein the liquefaction unit is in fluid communication with the gas processing unit, such that the liquefaction unit and the gas processing unit are configured to send and receive fluids from each other;
c) extracting a letdown energy from a high pressure gas to produce refrigeration to be used within the liquefaction unit, thereby producing a low pressure gas, wherein the low pressure gas is then used by the gas processing unit as a low pressure feedstream;
d) liquefying an industrial gas within the liquefaction unit using refrigeration produced in step c).

2. The process as claimed in claim 1, wherein the gas processing unit is selected from the group consisting of a methanol plant, a steam methane reformer, a cogeneration plant, a partial oxidation unit, an autothermal reforming unit, and combinations thereof.

3. The process as claimed in claim 1, wherein the industrial gas is selected from the group consisting of an air gas, a hydrocarbon, syngas, carbon dioxide, hydrogen, carbon monoxide, and combinations thereof.
